(19) United States
(12) Patent Application Publication
(10) Pub. No.: US 2010/0134550 A1
(43) Pub. Date: Jun. 3, 2010

(54) PRINTING CONTROL APPARATUS, PRINTING SYSTEM, AND PRINTING CONTROL PROGRAM

(75) Inventors: Takashi ITO, Hata-machi (JP); Jun HOSHII, Shiojiri (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 12/567,378

(22) Filed: Sep. 25, 2009

(30) Foreign Application Priority Data
Dec. 3, 2008 (JP) 2008-309030

(51) Int. Cl. B41J 2/21

(52) U.S. Cl. 347/15

(57) ABSTRACT

A printing control apparatus includes a printing unit which designates a color material amount set corresponding to a designated index by referring to a lookup table defining a correspondence between the index that specifies a target value that is information indicating a color of an object and a target color material amount set that is the color material amount set of which approximation to the target value is maximized. The target color material amount set is a second color material amount set obtained by predicting a first color material amount set based on a predetermined prediction model so that the approximation is maximized while the used amount of the low-concentration color material is suppressed and by using the first color material amount set as an initial value of the predetermined prediction model so that the approximation is maximized while the used amount of the high-concentration color material is suppressed.

### BACKGROUND

1. Technical Field

The present invention relates to a printing control apparatus, a printing system, and a printing control program, and more particularly, to a printing control apparatus, a printing system, and a printing control program, each of which allows a printing apparatus to perform printing by fixing on a recording medium a plurality of color materials which includes high-concentration and low-concentration color materials of which hues are substantially equal to each other with respect to at least one hue and of which concentrations are different, wherein each of the printing control apparatus, the printing system, and the printing control program designates a color material amount set that is a combination of used amounts of the color materials to the printing apparatus and allows the printing apparatus to perform printing based on the color material amount set.

2. Related Art

A printing method regarding spectroscopical reproducibility is proposed (refer to Patent Document JP-T-2005-508125). In the Patent Document, in order to perform a spectroscopically, colorimetrically matched printing on a target image, a combination of printer colors (CMYKOG) is optimized by using a printing model so as to fit to a spectral reflectance (target spectrum) of a target. In this manner, the target image can be reproduced spectroscopically by performing the printing based on the printer colors (CMYKOG). As a result, a print result with a high colorimetric reproducibility can be obtained.

Due to the printing model, the print result can be predicted without actually performing printing. However, the result of the prediction of the printing model may not be coincident with the actual printing result. For example, in the case where the accuracy of the printing model is poor or the case where the accuracy of the printing model is high but the optimized conditions (an initial condition or an objective function setting method) of the prediction of the printing model is not good, there is a problem in that the reproduction result that is predicted in the printing model cannot be obtained.

### SUMMARY

An advantage of some aspects of the invention is to provide a printing control apparatus, a printing system, and a printing control program capable of efficiently implementing color reproduction with a high accuracy.

According to an aspect of the invention, there is provided a printing control apparatus which allows a printing apparatus to perform printing by fixing on a recording medium a plurality of color materials which includes high-concentration and low-concentration color materials of which hues are substantially equal to each other with respect to at least one hue and of which concentrations are different, the printing control apparatus designating a color material amount set that is a combination of used amounts of the color materials to the printing apparatus and allowing the printing apparatus to perform printing based on the color material amount set, the printing control apparatus comprising a printing unit.

The printing unit designates the color material amount set corresponding to a designated index to the printing apparatus by referring to a lookup table that defines a correspondence between the color material amount set and an index and allows the printing apparatus to perform printing. In other words, the lookup table includes an index that specifies a target value that is information indicating a color of an object. The color material amount set corresponding to the index is a color material amount set (target color material amount set) by which approximation to the target value is maximized when the color material amount set is attached on the recording medium in the printing apparatus.

Herein, the target color material amount set is calculated as follows. Firstly, a color material amount set (first color material amount set) is predicted based on a predetermined prediction model so that the used amount of the low-concentration color material is suppressed (in other words, the used amount of the high-concentration color material is increased with priority) and the approximation is maximized. Next, a color material amount set (second color material amount set) is predicted based on the predetermined prediction model by using the first color material amount set as an initial value of the predetermined prediction model so that the used amount of the high-concentration color material is suppressed (in other words, the used amount of the low-concentration color material is increased with priority) and the approximation is maximized. As a result, the calculated second color material amount set is the target color material amount set. In other word, in the determination of the color material amounts with respect to the color material amount sets that reproduce the color approximate to the target value on the recording medium, the color material amount set that suppresses an increase in a total of the attached amount of the color material on the recording medium can be calculated by allocating the high-concentration color material with priority, and the color material amount set that can reproduce color with a high accuracy can be calculated by allocating the low-concentration color material with priority with respect to a denseness of fine colors that cannot be reproduced by using the high-concentration color material.

In addition, a spectral reflectance or color value of the object can be used as the target value. If the spectral reflectance is used as the target value, printing having a good reproducibility of the spectral reflectance can be performed by the printing apparatus. In this case, the prediction model predicts a spectral reflectance of the case where the printing is performed by using an arbitrary one of the color material amount sets. In addition, by using color values under a plurality of light sources for the target as the target value, printing having a good reproducibility of the colors under a plurality of the light sources can be performed by the printing apparatus. In this case, the prediction model predicts color values under a plurality of the light sources in the case where the printing is performed by using an arbitrary one of the color material amount sets. In addition, the printing apparatus may print at least a plurality of the color materials on the recording medium. Various printing apparatuses such as an ink jet printer, a laser printer, and a sublimation printer can be adapted to the invention.

In addition, in a selective one of aspects of the invention, the target value may be a corrected target value that can be obtained as follows. The corrected target value is a value obtained by predicting the color material amount set for reproducing the target value on the recording medium in the printing apparatus based on the predetermined prediction model, by designating the predicted color material amount set to the printing apparatus to print a checking patch, and by setting up the value based on a deviation between a checked target value that is information indicating a color of the checking patch and a measured target value that is a colorimetric value of the object.

As a result, a prediction result from which the deviation is removed can be obtained. Therefore, even in the case where the accuracy of the printing model is poor, even in the case where the accuracy of the printing model is high but reproduction characteristics of the printer vary with time, or even in the case where the reproduction characteristics of individual printers are not uniform, a prediction result with a high accuracy can be obtained. In addition, the deviation is not simply subtracted from the target value, but for example, any portion of the deviation may be subtracted.

In addition, in a selective one of aspects of the invention, a re-checking patch may be printed by designating the second color material amount set to the printing apparatus, and re-prediction of the first color material amount set and the second color material amount set may be performed by using a re-corrected target value, which is calculated based on a deviation between a re-checked target value that is information indicating a color of the re-checking patch and the measured target value, as the target value.

In other words, the printing apparatus is allowed to actually perform printing based on the predicted second color material amount set, and colorimetry is performed on the print result, so that the colorimetric value is used as a new target value (re-corrected target value). Next, a color material amount set for reproducing the new target value is predicted. Accordingly, feedback is provided based on the print result of the predicted second color material amount set and the prediction accuracy can be further improved.

In addition, in a selective one of aspects of the invention, in the predetermined prediction model, when the color material amount set is to be predicted, the approximation of the color material amount set may be evaluated while the color material amount is changed by small amounts, each of which is smaller than a minimum unit amount that can be fixed in the printing apparatus, and the color material amount set predicted based on the predetermined prediction model may be obtained by performing a number rounding process on the color material amount set, of which the approximation is maximized, using the unit amount as a rounding width. When the number rounding process is executed, a rounding error occurs. Since the rounding error occurring due to the color material amount of the high-concentration color material is smaller than the unit amount of the high-concentration color material, although the color material amount of the high-concentration color material is changed by performing the re-prediction, the probability of occurrence of a similar rounding error is high. Therefore, although the number rounding process is executed with respect to the color material amount set allocated with the high-concentration color material with priority as described above, in this case, the prediction is performed with the low-concentration color material that is allocated with priority. As a result, the color material amount corresponding to the rounding error of the high-concentration color material is compensated for by the color material amount of the low-concentration color material so as to be converted to the color material amount of the low-concentration color material. Accordingly, the color material amount set with high accuracy in terms of color reproducibility can be predicted.

In addition, in a selective one of aspects of the invention, the processes of predicting the first color material amount set and the second color material amount set may be repeated several times by using the predicted second color material amount set as the initial value, and in the case where the same amounts used of the high-concentration color material of the second color material amount set are detected two times consecutively in the repeated processes, the used amount of the high-concentration color material may be fixed in the next repeated processes.

In general, the accuracy of the optimization can be improved by repeating the optimization process several times. However, in the case where the step of change is large as in the high-concentration color material of the invention, the accuracy is not greatly improved by increasing the number of repetitions. Therefore, in the case where the high-concentration color material is optimized to the same value consecutively two times, the processing time can be shortened by not performing the next optimization. This effect is dominant in the case where the second color material amount set is in the vicinity of the optimal solution thereof. Since the process required for this case is a process of optimization for compensating the rounding error, if the prediction is performed by changing the high-concentration color material, the error from the optimal solution is increased, but there is no advantage.

In addition, in a selective one of aspects of the invention, in the prediction of each of the first color material amount set and the second color material amount set, color change in the entire hue directions can be performed by using a combination of color materials excluding ink of which the used amount is suppressed. In a detailed aspect for securing a degree of freedom in the entire hue directions, the plurality of the color materials may include cyan (C), magenta (M), yellow (Y), black (K), light cyan (lc), and light magenta (lm) color materials, the amounts used of at least the cyan (C), the magenta (M), and the black (K) color materials may be changed with priority in the prediction of the first color material amount set, and the amounts used of at least the light cyan (lc), the light magenta (lm), and the yellow (Y) color materials may be changed with priority in the prediction of the second color material amount set.

In the above configuration, the CMYK are the high-concentration color materials, and the lclm are the low-concentration color materials. However, in this combination of the ink set, the color change in the yellow direction cannot be implemented by using only the lc and lm. Therefore, although the prediction is performed in the prediction model using the two colors, the error in the yellow direction cannot be removed, so that the accuracy of the prediction is lowered. For this reason, in the case where low-concentration color material is changed with priority, the prediction is performed by changing the Y together with the lclm, so that the color change in all hue directions can be implemented. Needless to say, if a low-concentration color material (light yellow or the like) that can generate the color change in the yellow direction is included in the color material set, the Y does not need to be changed together with the low-concentration color material, but the prediction of the first color material amount set as CMYK may be performed.

In addition, the technical idea of the invention can be implemented with a specific printing control apparatus, or a method thereof. In other words, the invention may be specified by a method having steps corresponding to components that are performed by the aforementioned printing control apparatus. Needless to say, in the case where the aforementioned printing control apparatus reads a program and implements the aforementioned components, the invention can be implemented by a program that executes functions corresponding to the components or various recording media that record the program. In addition, the printing control apparatus according to the invention can be configured with a single apparatus or be distributed over a plurality of apparatuses. For example, the components representing states of the printing control apparatus may be distributed to a printer driver that is executed on a personal computer and a printer. In addition, the components of the printing apparatus according to the invention may be included in a printing apparatus such as a printer.

### BRIEF DESCRIPTION OF THE DRAWINGS

The invention will be described with reference to the accompanying drawings, wherein like numbers reference like elements.

FIG. 1 is a block diagram showing a hardware configuration of a printing control apparatus.

FIG. 2 is a block diagram showing a software configuration of the printing control apparatus.

FIG. 3 is a flowchart of a printing data generation process.

FIG. 4 is a view showing an example of a UI screen.

FIG. 5 is a view for explaining calculation of a color value based on a spectral reflectance.

FIG. 6 is a view showing printing data.

FIG. 7 is a view showing an index table.

FIG. 8 is a flowchart showing the entire flow of a printing control process.

FIG. 9 is a flowchart of a 1D-LUT generation process.

FIG. 10 is a diagrammatic view showing a flow of a process of optimizing an ink amount set.

FIG. 11 is a diagrammatic view showing a behavior where the ink amount set is optimized.

FIG. 12 is a view showing a 1D-LUT.

FIG. 13 is a flowchart of a printing control data generation process.

FIG. 14 is a view showing a 3D-LUT.

FIG. 15 is a flowchart of a calibration process.

FIG. 16 is a flowchart of a calibration process.

FIG. 17 is a graph for explaining a deviation.

FIG. 18 is a conceptual view showing a color change per unit amount of each ink for a predetermined hue.

FIG. 19 is a diagrammatic view showing a printing scheme of a printer.

FIG. 20 is a view showing a spectral reflectance database.

FIG. 21 is a view showing a spectral Neugebauer model.

FIG. 22 is a view showing a cellular Yule-Nielsen spectral Neugebauer model.

FIG. 23 is a diagrammatic view showing a weighting function according to a modified example.

FIG. 24 is a diagrammatic view showing a weighting function according to a modified example.

FIG. 25 is a diagrammatic view showing a weighting function according to a modified example.

FIG. 26 is a view showing a UI screen according to a modified example.

FIG. 27 is a diagrammatic view showing an evaluated value according to a modified example.

FIG. 28 is a diagrammatic view showing a corrected target color value according to a modified example.

FIG. 29 is a flowchart of a calibration process according to a modified example.

FIG. 30 is a graph for explaining a weighting function according to a modified example.

FIG. 31 is a flowchart of a 1D-LUT generation process according to a modified example.

FIG. 32 is a view showing a software configuration of a printing system according to a modified example.

FIG. 33 is a view showing a software configuration of a printing system according to a modified example.

### DESCRIPTION OF EXEMPLARY EMBODIMENTS

Hereinafter, an embodiment of the invention will be described in the order of the following list.

### 1. Configuration of Printing Control Apparatus:

### 2. Printing Data Generating Process:

### 3. Printing Control Process:

### 3-1. 1D-LUT Generation Process:

### 3-2. Printing Control Data Generating Process:

### 4. Calibration Process:

### 5. Spectral Printing Model:

### 6. Modified Example:

### 6-1. Modified Example 1:

### 6-2. Modified Example 2:

### 6-3. Modified Example 3:

### 6-4. Modified Example 4:

### 6-5. Modified Example 5:

### 6-6. Modified Example 6:

### 6-7. Modified Example 7:

### 6-8. Modified Example 8:

### 1. Configuration of Printing Control Apparatus

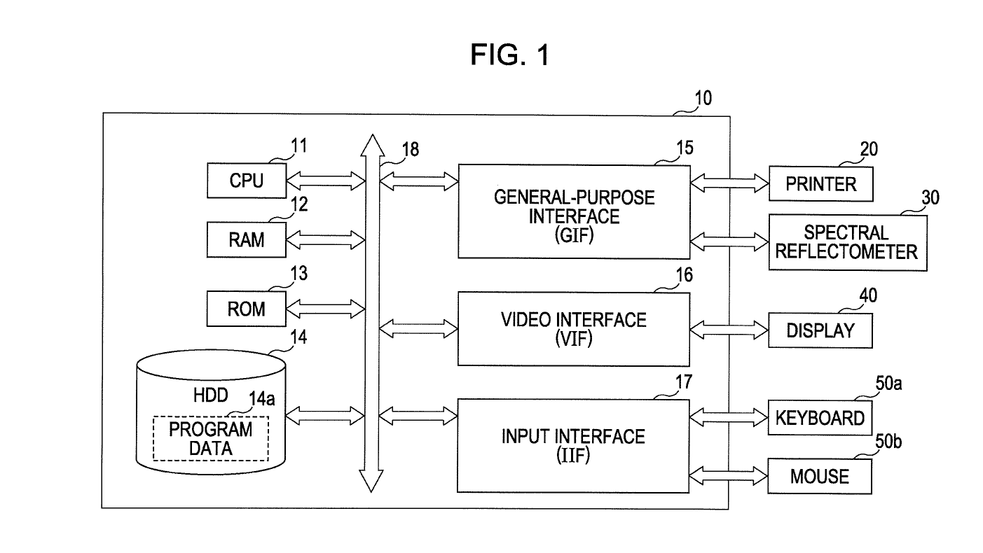

FIG. 1 shows a hardware configuration of a printing control apparatus according to an embodiment of the invention. In the figure, the printing control apparatus is mainly constructed with a computer 10. The computer 10 includes a CPU 11, a RAM 12, a ROM 13, a hard disk drive (HDD) 14, a general-purpose interface (GIF) 15, a video interface (VIF) 16, an input interface (IIF) 17, and a bus 18. The bus 18 is used to implement data communication between components 11 to 17 of the computer 10, and the communication is controlled by a chip set (not shown) or the like. The HDD 14 stores program data 14a used to execute various programs including an operating system (OS). The program data 14a are expanded to the RAM 12, and the CPU 11 executes calculation based on the program data 14a. The GIF 15 provides an interface based on, for example, a USB standard to connect an external printer 20 and a spectral reflectometer 30 to the computer 10. The VIF 16 provides an interface to connect the computer 10 to an external display 40 so as to display an image on the display 40. The IIF 17 provides an interface to connect the computer 10 to external keyboard 50a and mouse 50b so as for the computer 10 to acquire input signals from the keyboard 50a and the mouse 50b.

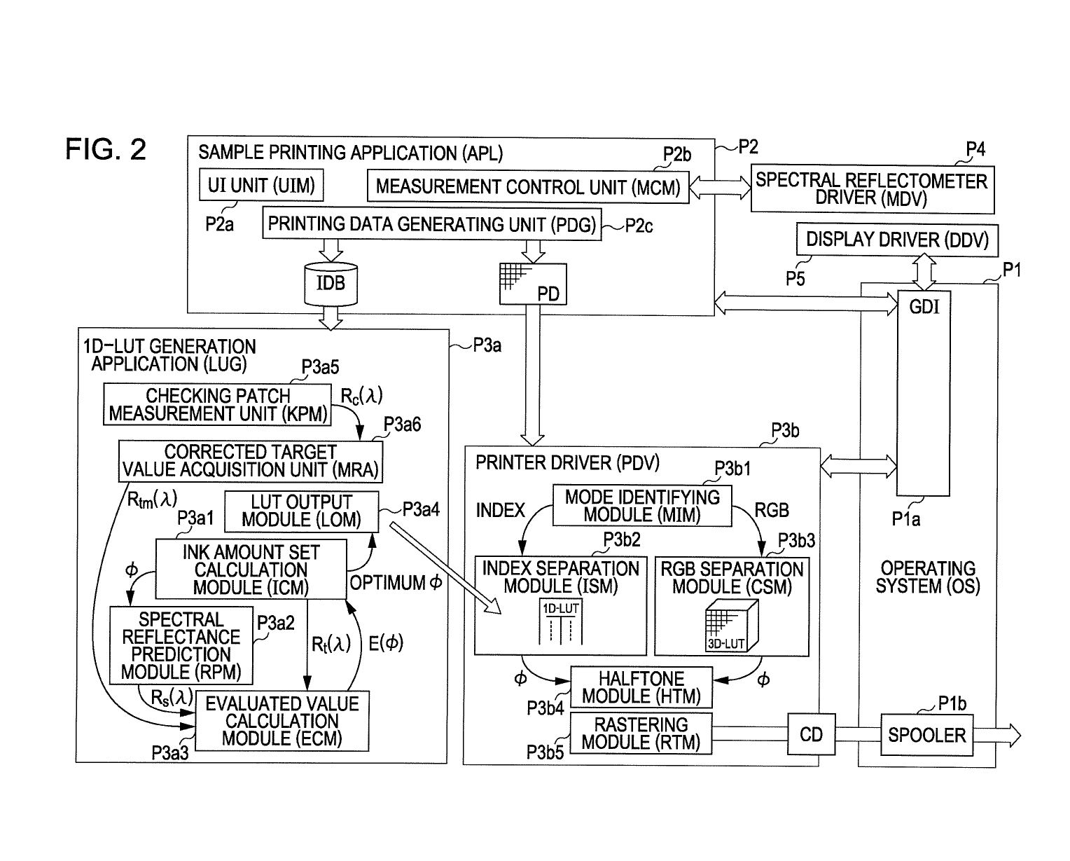

FIG. 2 shows a software configuration of programs executed in the computer 10 together with a schematic data flow. In the figure, in the computer 10, an OS P1, a sample printing application (APL) P2, a 1D-LUT generation application (LUG) P3a, a printer driver (PDV) P3b, a spectral reflectometer driver (MDV) P4, and a display driver (DDV) P5 are mainly executed. The OS P1 is an API which can be used by each program. The OS P1 provides an image apparatus interface (GDI) P1a and a spooler P1b. In response to a request of the APL P2, the GDI P1a is called out. In addition, in response to a request of the GDI P1a, the PDV P3b or the DDV P5 are called out. The GDI P1a provides a general-purpose structure in which the computer 10 can control image output in an image output apparatus such as the printer 20 or the display 40, and on the other hand, the PDV P3b or the DDV P5 provides apparatus-specified processes of the printer 20 or the display 40. In addition, the spooler P1b is disposed between the APL P2 or the PDV P3b and the printer 20 so as to execute control of tasks. The APL P2 is an application for printing a sample chart SC so as to generate printing data PD in the RGB bitmap format and to output the printing data PD to the GDI P1a. In addition, with respect to the generation of the printing data PD, spectral reflectance data RD of a target are acquired from the MDV P4. The MDV P4 controls the spectral reflectometer 30 in response to a request of the APL P2 and outputs spectral reflectance data RD that is acquired through the control to the APL P2.

The printing data PD generated by the APL P2 are output through the GDI P1a or the spooler P1b to the PDV P3b. The PDV P3b executes a process of generating printing control data CD which can be output to the printer 20 based on the printing data PD. The printing control data CD generated by the PDV P3b are output to the printer 20 through the spooler P1b that is provided by the OS P1. The printer 20 performs operations based on the printing control data CD, so that the sample chart SC is printed on a printing sheet. The whole process flow is described above in brief. Hereinafter, the processes executed by the programs P1 to P4 will be described in detail by using flowcharts.

### 2. Printing Data Generation Process

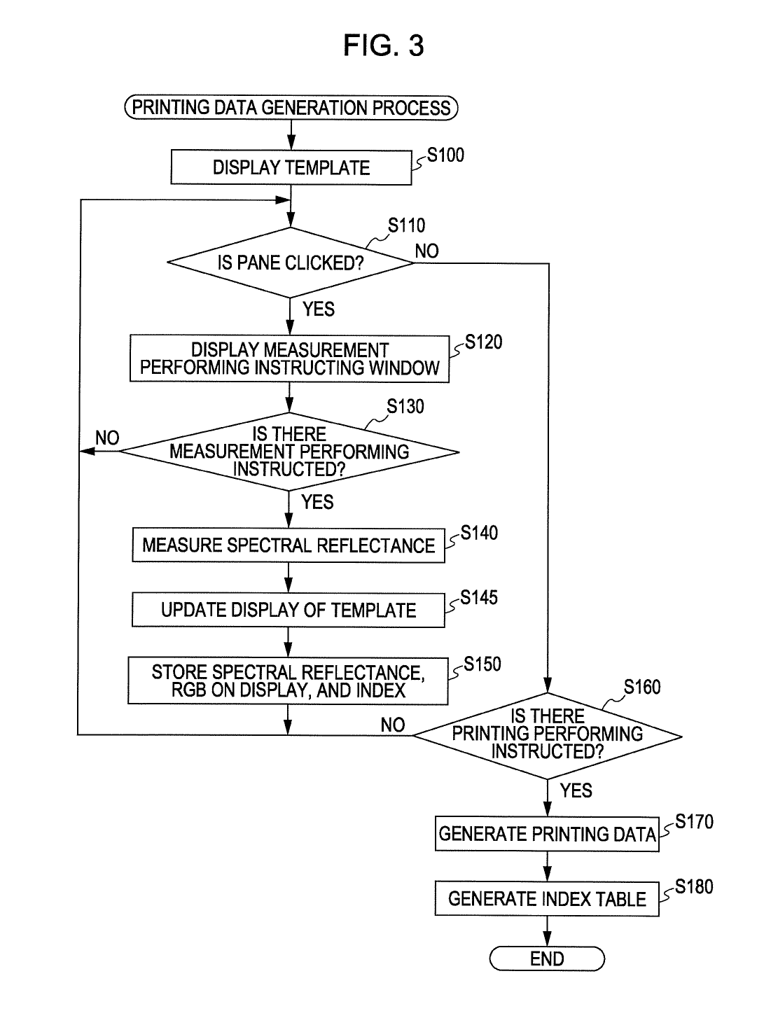

FIG. 3 shows a flow of the printing data generation process that is executed by the APL P2. As shown in FIG. 2, the APL P2 includes a UI unit (UIM) P2a, a measurement control unit (MCM) P2b, and a printing data generation unit (PDG) P2c. Each of the modules P2a, P2b, and P2c performs each of the steps shown in FIG. 3. In the step S100, the UIM P2a displays a UI screen for receiving a printing instruction of printing the sample chart SC through the GDI P1a and the DDV P5. On the UI screen, a display showing a template of the sample chart SC is disposed.

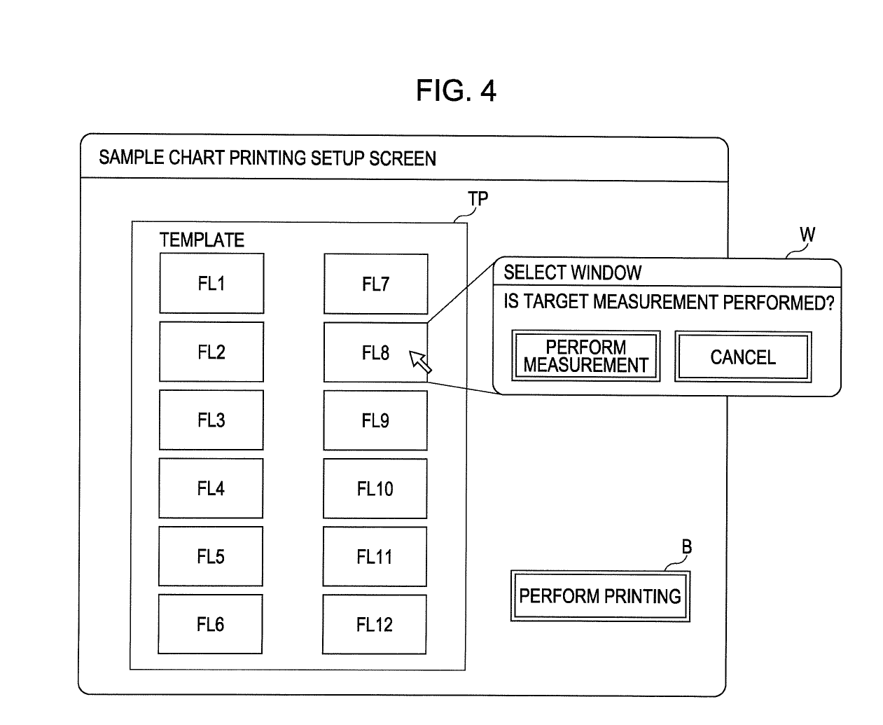

FIG. 4 shows an example of the UI screen. In the figure, the template TP is displayed, and 12 panes FL1 to FL12 for laying out color patches are disposed in the template TP. In the UI screen, each of the panes FL1 to FL12 can be selected by clicking the mouse 50b. When one of the panes FL1 to FL12 is clicked, a select window W for instructing whether or not to start spectral reflectance measurement is displayed. In addition, in the UI screen, a button B for instructing whether or not to perform the printing of the sample chart SC is also disposed. In the step S110, the UIM P2a detects whether or not the mouse 50b clicks each of the panes FL1 to FL12. If the clicking is detected, in the step S120, a select window W for instructing whether or not to start the spectral reflectance measurement is displayed. In the step S130, the clicking of the mouse 50b in the select window W is detected. In the case where “CANCEL” is clicked, the process returns to the step S110. On the other hand, in the case where the spectral reflectance measurement execution is clicked, in the step S140, the MCM P2b allows the spectral reflectometer 30 to measure a target spectral reflectance Rₜ(λ), that is, the spectral reflectance R(λ) of the target TG by using the MDV P4, so that spectral reflectance data RD including the target spectral reflectance Rₜ(λ) is acquired. The target spectral reflectance Rₜ(λ) corresponds to a target value and a state value including a state of the target according to the invention.

In the step S140, when the measurement of the target spectral reflectance Rₜ(λ) is ended, a color value (L*a*b* value) in the CIELAB color space corresponding to the time when the D65 light source, that is, the most standard light source is illuminated is calculated. Next, the L*a*b* value is converted to a RGB value by using a predetermined RGB profile, so that the RGB value is acquired as an RGB value on display. The RGB profile is a profile defining a color matching relationship between the CIELAB color space that is an absolute color space and the RGB color space according to the embodiment. For example, an ICC profile can be used.

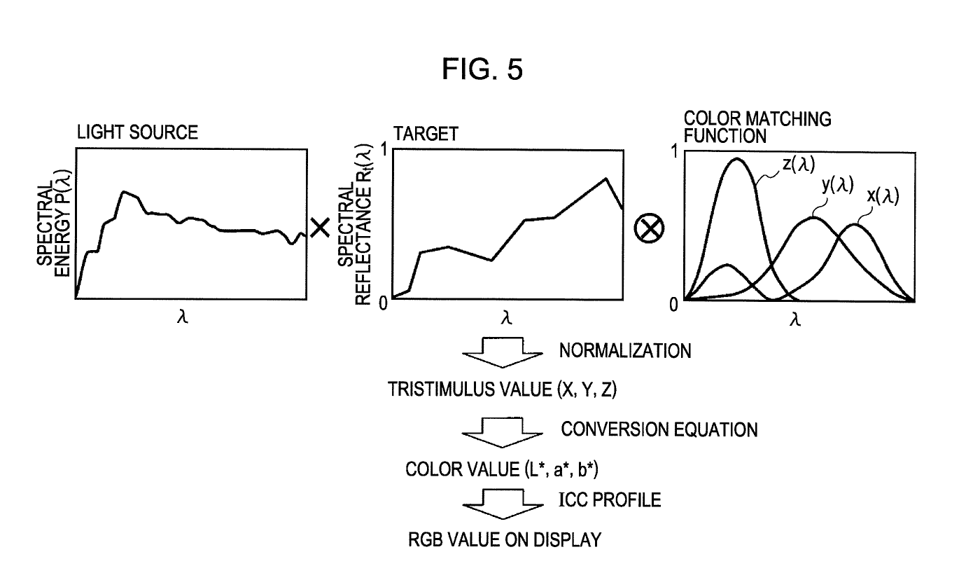

FIG. 5 diagrammatically shows a process of calculating the RGB value on display from the spectral reflectance data RD in the step S140. As a result of the measurement of the target spectral reflectance Rₜ(λ) of the target TG, the spectral reflectance data RD representing a distribution of the target spectral reflectance Rₜ(λ) as shown in the figure can be obtained. In addition, the target TG denotes a surface of an object that is a target of the spectral reproduction. For example, a surface of an artificial object that is formed by other printing apparatuses or painting apparatuses or a surface of a natural object corresponds to the target TG. On the other hand, the D65 light source has a distribution of the spectral energy P(λ) that is not uniform over a visible wavelength range as shown in the figure. The spectral energy of the reflected light at each wavelength at the time when the target TG is illuminated with the D65 light source is a value of the multiplication of the target spectral reflectance Rₜ(λ) and the spectral energy P(λ) for each wavelength. In addition, by performing convolution integration of each of color matching functions x(λ), y(λ), and z(λ) according to the human spectral sensitivity characteristics over the spectrum of the spectral energy of the reflected light and performing normalization with a coefficient k, tristimulus values X, Y, and Z are obtained. The above calculation can be expressed by the following Equation 1.

Equation 1

X=k∫P(λ)Rₜ(λ)x(λ)dλ

Y=k∫P(λ)Rₜ(λ)y(λ)dλ

Z=k∫P(λ)Rₜ(λ)z(λ)dλ (1)

By converting the tristimulus values X, Y, and Z with a predetermined conversion equation, the L*a*b* value indicating the color at the time when the target TG is illuminated with the D65 light source can be obtained, and by using the RGB profile, the RGB value on display can be obtained. In the step S145, in the template TP, the clicked panes FL1 to FL12 are updated with the displays which are entirely painted with the RGB value on display. Therefore, it is possible to sensitively perceive the color of the target TG in the D65 light source that is a standard light source from the UI screen. If the step S145 is ended, in the step S150, the unique index is generated, and the index, the RGB value on display and the position information of the panes FL1 to FL12 clicked in the step S110 are corresponded to the spectral reflectance data RD and stored in the RAM 12. If the step S150 is ended, the process returns to the step S110, and the steps S120 to S150 are repeatedly executed. Therefore, the other of the panes FL1 to FL12 is selected, and the target spectral reflectance Rₜ(λ) of the other target TG with respect to the other of the panes FL1 to FL12 can be measured.

In the embodiment, 12 kinds of targets, that is, the targets TG1 to TG12 that are different from each other are prepared, and the target spectral reflectances Rₜ(λ) corresponding to the targets TG1 to TG12 are acquired as the spectral reflectance measurement data RD. Therefore, in the step S150, the data obtained by corresponding the spectral reflectance measurement data RD to the unique indexes with respect to the panes FL1 to FL12 are sequentially stored in the RAM. In addition, each of the values of the indexes may be generated to be unique. In addition, each of the values of the indexes may be generated by increments or by random numbers that are not overlapped.

In the step S110, in the case where the clicking of the panes FL1 to FL12 is not detected, in the step S160, the clicking of a button B indicating the performing of the printing of the sample chart SC is checked to be detected. If the clicking is not detected, the process returns to the step S110. On the other hand, in the case where the clicking of the button B indicating the performing of the printing of the sample chart SC is detected, in the step S170, the PDG P2c generates the printing data PD.

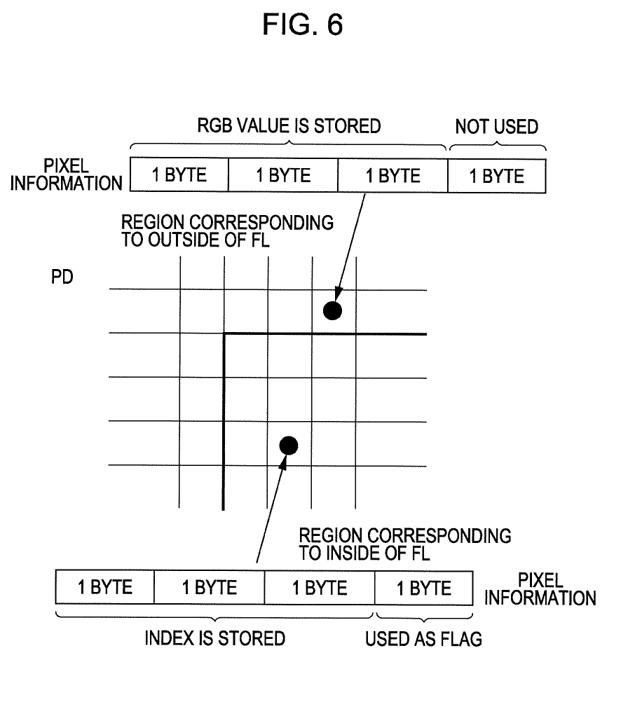

FIG. 6 diagrammatically shows a configuration of the printing data PD. In the figure, the printing data PD are configured with a plurality of pixels that are arrayed in a dot matrix shape, and each pixel has 4-byte ((8 bits)×4) information. The printing data PD represents the same image as that of the template TP shown in FIG. 4. The pixels outside the regions corresponding to the panes FL1 to FL12 of the template TP have the RGB values of the colors corresponding to the template TP. Each gradation value of each RGB channel is represented by eight bit (256 gradations). 3 bytes among the aforementioned 4 bytes are used to store the RGB value. For example, in the case where the colors outside the panes FL1 to FL12 of the template TP are represented by constant intermediate gray, that is, (R, G, B)=(128, 128, 128), the pixels outside the regions corresponding to the panes FL1 to FL12 in the printing data PD have color information of (R, G, B)=(128, 128, 128). In addition, the remaining 1 byte is not used.

On the other hand, the pixels corresponding to the panes FL1 to FL12 of the template TP also have 4-byte information. In general, the index is stored by using 3 bytes in which the RGB value is stored. The index is the unique index that is generated for each of the panes FL1 to FL12 in the step S150. The PDG P2c acquires the index from the RAM 12 and stores the index corresponding to the pixel corresponding to each of the panes FL1 to FL12. With respect to the pixel corresponding to each of the panes FL1 to FL12 that store the index instead of the RGB value, a flag denoting that the index is stored therein by using the remaining 1 byte is set up. As a result, it can be determined whether each pixel stores the RGB value or the index. In the embodiment, since 3 bytes can be used to store the index, the index that can be represented by an information amount of 3 bytes or less needs to be generated in the step S150. If the printing data PD in the bitmap format can be generated in this manner, in the step S180, the PDG P2c generates an index table IDB.

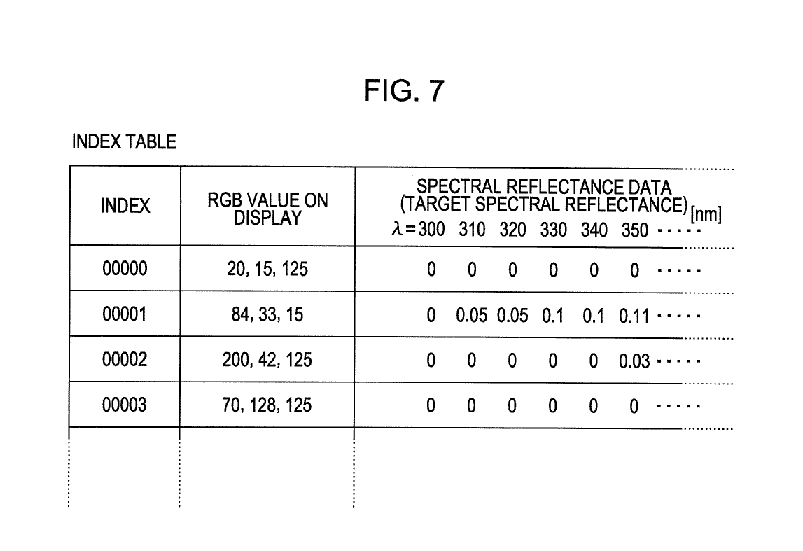

FIG. 7 shows an example of the index table IDB. In the figure, with respect to each of the unique indexes that are generated corresponding to each of the panes FL1 to FL12, the target spectral reflectance Rₜ(λ) that can be obtained by measurement and the RGB value on display corresponding to the L*a*b* value of the D65 light source are stored. When the generation of the index table IDB is ended, the printing data PD are output through the GDI P1a or the spooler P1b to the PDV P3b. Since the bitmap format of the printing data PD is the same as a general RGB bitmap format in terms of outer appearance, the GDI P1a or the spooler P1b provided by the OS P1 also performs the same general printing operations. On the other hand, the index table IDB is directly output to the PDV P3b. In addition, in the embodiment, although the index table IDB is newly generated, the new correspondence of the indexes to the target spectral reflectances Rₜ(λ) and the RGB values on display may be added to an existing index table IDB. In addition, the aforementioned printing data generation process and the later-described printing control process are not necessarily executed consecutively in the same apparatus, but the printing data generation process and the printing control process may be executed, for example, in a plurality of computers that are connected to each other via a communication line such as a LAN or the Internet.

### 3. Printing Control Process

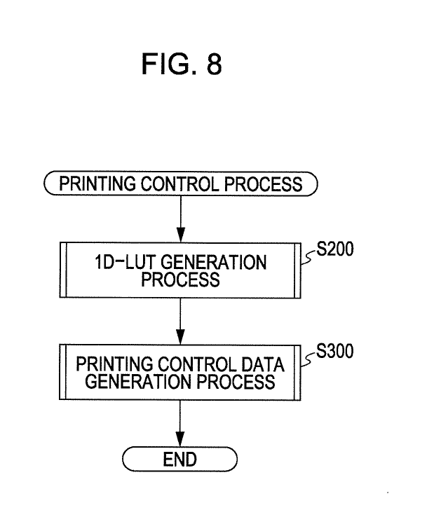

FIG. 8 shows the entire flow of the printing control process that is performed by the LUG P3a and the PDV P3b. A 1D-LUT generation process (step S200) shown in FIG. 8 is performed by the LUG P3a. A printing control data generation process (step S300) is performed by the PDV P3b. The 1D-LUT generation process may be performed prior to the printing control data generation process. In addition, the 1D-LUT generation process and the printing control data generation process may be performed simultaneously.

3-1. 1D-LUT generation Process

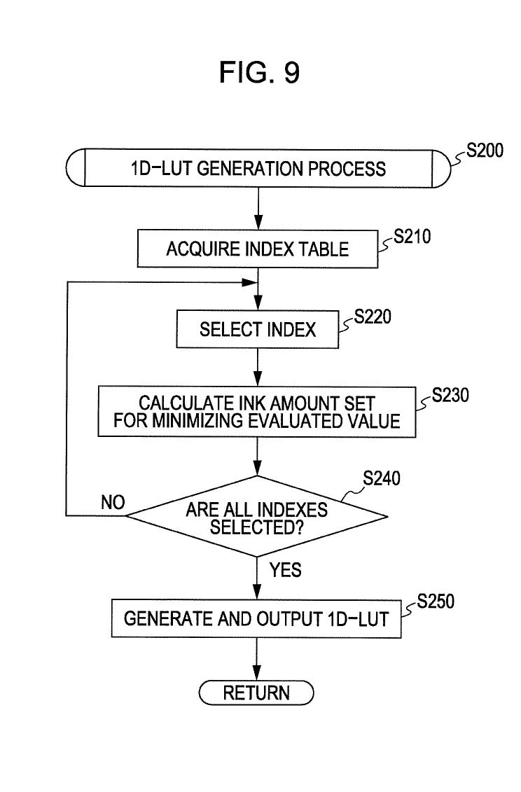

FIG. 9 shows a flow of the 1D-LUT generation process. As shown in FIG. 2, the LUG P3a includes an ink amount set calculation module (ICM) P3a1, a spectral reflectance prediction module (RPM) P3a2, an evaluated value calculation module (ECM) P3a3, and an LUT output module (LOM) P3a4. In the step S210, the ICM P3a1 acquires the index table IDB. In the step S220, one index is selected from the index table IDB, and the spectral reflectance data RD corresponding to the index is acquired. In the step S230, the ICM P3a1 performs a process of calculating an ink amount set that can reproduce the same spectral reflectance R(λ) as the target spectral reflectance Rₜ(λ) indicated by the spectral reflectance data RD. At this time, the aforementioned RPM P3a2 and ECM P3a3 are used.

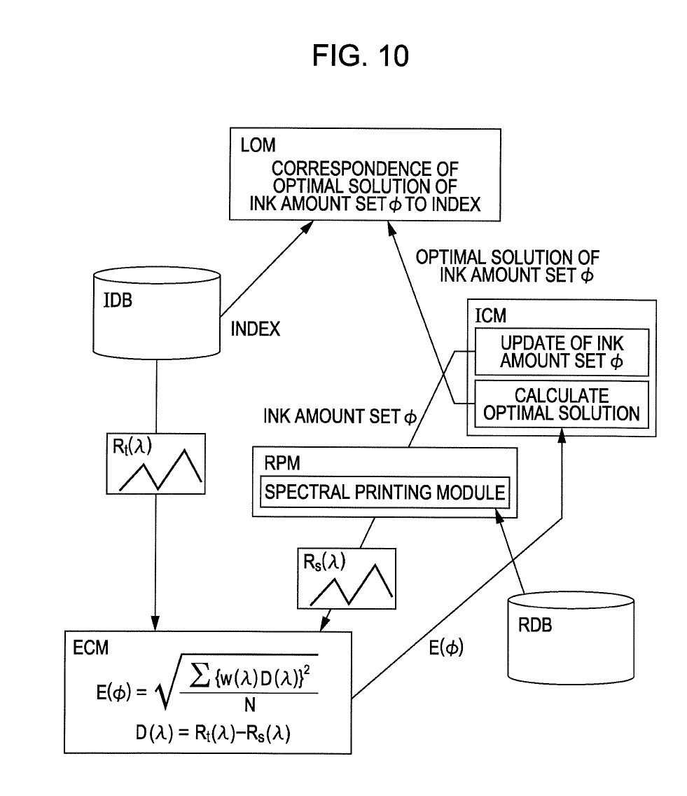

FIG. 10 diagrammatically shows the process of calculating the ink amount set that can reproduce the same spectral reflectance R(λ) as the target spectral reflectance Rₜ(λ) indicated by the spectral reflectance data RD. In response to the input of the ink amount set φ from the ICM P3a1, the RPM P3a2 predicts the spectral reflectance R(λ) at the time when the printer 20 ejects ink on a predetermined printing sheet based on the ink amount set φ and outputs the spectral reflectance R(λ) as a predicted spectral reflectance Rₛ(λ) to the ECM P3a3.

The ECM P3a3 calculates a difference D(λ) between the target spectral reflectance Rₜ(λ) indicated by the spectral reflectance data RD and the predicted spectral reflectance Rₛ(λ) with respect to each wavelength λ and multiplies the difference D(λ) by a weighting function w(λ) in which weighting is provided for each wavelength λ. A root mean square of the value is calculated as an evaluated value E(φ). The above calculation can be expressed by the following Equation 2.

$$\begin{matrix}Equation 2 & \\ E ( ϕ ) = \sqrt{\frac{\sum {\{ w ( λ ) D ( λ ) \}}^{2}}{N}} \\ D ( λ ) = {R}_{1} ( λ ) - {R}_{s} ( λ ) & ( 2 )\end{matrix}$$

In the above Equation 2, N denotes a finite number of partitions of a wavelength λ. In the above Equation 2, it can be understood that, the smaller the evaluated value E(φ) is, the smaller the difference between the target spectral reflectance Rₜ(λ) and the predicted spectral reflectance Rₛ(λ) for each wavelength λ is. In other words, it can be stated that, as the evaluated value E(φ) becomes smaller, the spectral reflectance R(λ) that is reproduced on the recording medium at the time when the printer 20 performs the printing based on the input ink amount set φ and the target spectral reflectance Rₜ(λ) that can be obtained from the correspondence to the target TG become approximate to each other. In addition, according to the aforementioned Equation 1, it can be understood that, although absolute color values of the recording medium at the time when the printer 20 performs the printing based on the ink amount set φ and the corresponding target TG are changed according to a variation of the light source, if the spectral reflectances R(λ) thereof are approximate to each other, relatively the same color can be perceived irrespective of the variation of the light source. Therefore, according to the ink amount set φ of which evaluated value E(φ) is small, the print result that the same color as the target TG is perceived with respect to all the light sources can be obtained.

In addition, in the embodiment, the weighting function w(λ) expressed by the following Equation 3 is used.

Equation 3

w(λ)=x(λ)+y(λ)+z(λ) (3)

In the above Equation 3, the weighting function w(λ) is defined by adding the color matching functions x(λ), y(λ), and z(λ). In addition, a range of values of the weighting function w(λ) may be normalized by multiplying the entire right handed side of the above Equation 3 with a predetermined coefficient. According to the above Equation 1, it can be understood that, in the wavelength range where the color matching functions x(λ), y(λ), and z(λ) are large, the influence on the color value (L*a*b* value) becomes large. Therefore, if the weighting function w(λ) obtained by adding the color matching functions x(λ), y(λ), and z(λ) is used, the evaluated value E(φ) which can evaluate the square error emphasizing the wavelength range where the influence on the color is large can be obtained. For example, with respect to the near infrared wavelength range that cannot be perceived by human eyes, the weighting function w(λ) is 0, so that the difference D(λ) in the wavelength range does not contribute an increase in the evaluated value E(φ).

In other words, although the difference between the target spectral reflectance Rₜ(λ) and the predicted spectral reflectance Rₛ(λ) is not necessarily small over the entire visible wavelength range, if the target spectral reflectance Rₜ(λ) and the predicted spectral reflectance Rₛ(λ) are approximate to each other in the wavelength range that human eyes can perceive particularly well, the small evaluated value E(φ) can be obtained. Therefore, the evaluated value E(φ) can be used as an index of approximation to the spectral reflectance R(λ) suitable for the perception of human eyes. The calculated evaluated value E(φ) is returned to the ICM P3a1. In other words, the ICM P3a1 is configured to output an arbitrary ink amount set φ to the RPM P3a2 and the ECM P3a3, so that the evaluated value E(φ) is finally returned to the ICM P3a1. The ICM P3a1 repeatedly obtains the evaluated value E(φ) corresponding to an arbitrary ink amount set φ, so that an optimal solution of the ink amount set φ which minimizes the evaluated value E(φ) as a target function can be calculated. As a method of calculating the optimal solution, for example, a nonlinear optimization method that is called the gradient method can be used.

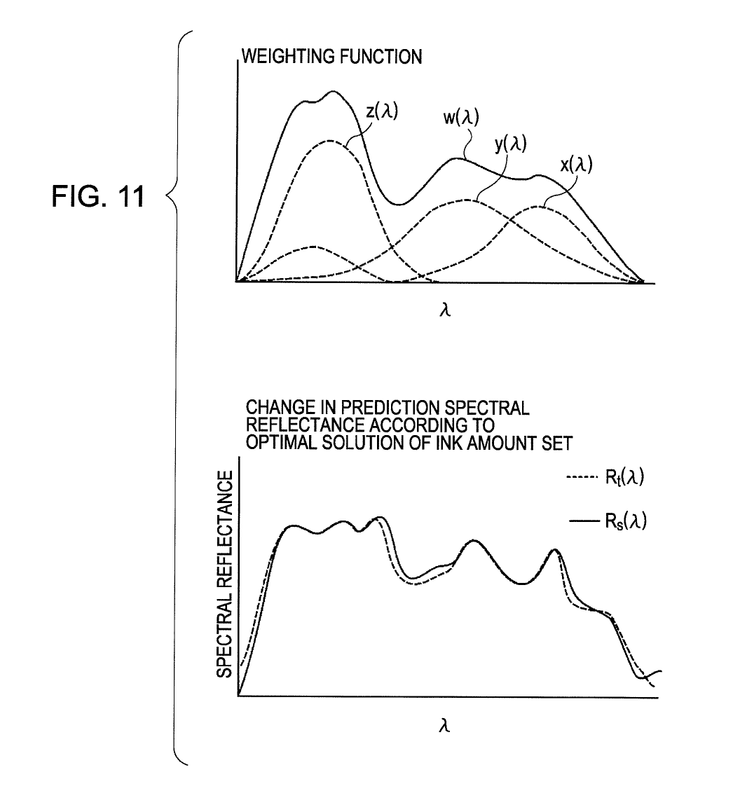

FIG. 11 diagrammatically shows a proceeding of optimization of the ink amount set φ in the step S230. In the figure, in the proceeding of the optimization of the ink amount set φ, the predicted spectral reflectance Rₛ(λ) of the case where the printing is performed based on the ink amount set φ is approximate to the target spectral reflectance Rₜ(λ). In addition, by using the weighting function w(λ), in the wavelength range where the color matching functions x(λ), y(λ), and z(λ) are large, the restraint of the predicted spectral reflectance Rₛ(λ) to the target spectral reflectance Rₜ(λ) is increased, so that the difference between the predicted spectral reflectance Rₛ(λ) and the target spectral reflectance Rₜ(λ) is decreased. In this manner, in the wavelength range where the color matching functions x(λ), y(λ), and z(λ) are large and the influence on visual perception is large, since the predicted spectral reflectance Rₛ(λ) can be restrained to the target spectral reflectance Rₜ(λ) of the target TG with priority, the ink amount set φ by which an appearance similar to the appearance at the time when an arbitrary light source is illuminated is obtained can be calculated. Therefore, the ink amount set φ by which the appearance similar to the target TG in any light source can be reproduced in the printer 20 can be calculated. In addition, the ending condition of the optimization may be the number of repetitions of the updating of the ink amount set φ or a threshold value of the evaluated value E(φ).

In this manner, if the ICM P3a1 calculates the ink amount set φ by which the same spectral reflectance R(λ) as the target TG can be reproduced in the step S230, in the step S240, it is determined whether or not all the indexes described in the index table IDB are selected in the step S220. In the case where none of the indexes are selected, the process returns to the step S220 to select the next index. Therefore, it is possible to calculate the ink amount set φ by which the same color as the target TG can be reproduced with respect to the all indexes. In other words, it is possible to calculate the ink amount set φ by which the same spectral reflectances R(λ) as the targets TG1 to TG12 can be reproduced with respect to all the targets TG1 to TG12 to which colorimetry is performed in the step S140 of the printing data generation process (refer to FIG. 2). If the ink amount set φ that is optimal with respect to all the indexes is determined to be calculated in the step S240, in the step S250, the LOM P3a4 generates the 1D-LUT and outputs the 1D-LUT to the PDV P3b.

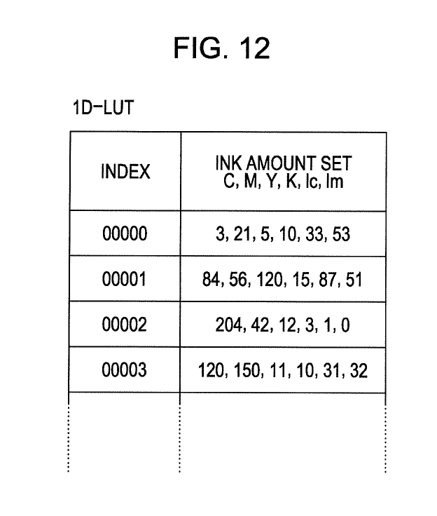

FIG. 12 shows an example of a 1D-LUT. In the figure, the optimal ink amount set φ corresponding to each index is stored. In other words, with respect to each of the targets TG1 to TG12, it is possible to prepare the 1D-LUT describing the ink amount set φ by which the appearance similar to each of the targets TG1 to TG12 can be reproduced in the printer 20. If the 1D-LUT is output to the PDV P3b, the 1D-LUT generation process is ended, and the next printing control data generation process (step S300) is executed.

### 3-2. Printing Control Data Generation Process

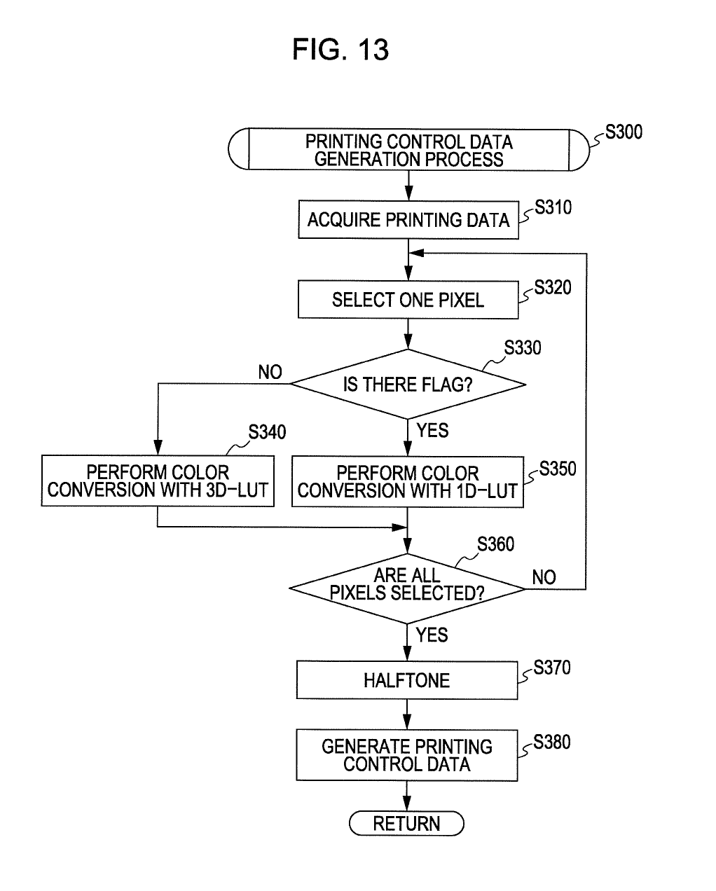

FIG. 13 shows a flow of the printing control data generation process. As shown in FIG. 2, the PDV P3b includes a mode identifying module (MIM) P3b1, an index separation module (ISM) P3b2, an RGB separation module (CSM) P3b3, a halftone module (HTM) P3b4, and a rastering module (RTM) P3b5. In the step S310, the mode identifying module (MIM) P3b1 acquires printing data PD. In the step S320, the MIM P3b1 selects one pixel from the printing data PD. In the step S330, the MIM P3b1 determines whether or not the flag denoting that the index is stored in the selected pixel is set up. In the case where the flag is not determined to be set up, in the step S340, the CSM P3b3 performs color conversion (separation) on the pixel with reference to the 3D-LUT.

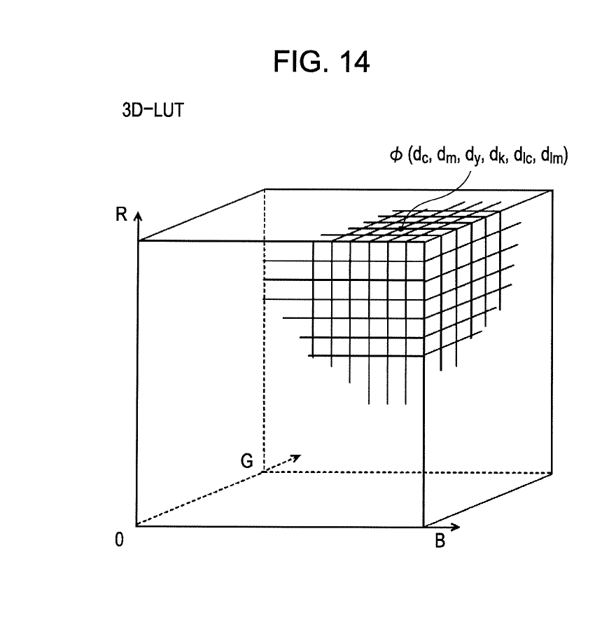

FIG. 14 shows an example of a 3D-LUT. In the figure, the 3D-LUT is a table that describes a correspondence between the RGB value and the ink amount set φ(d_{C}, d_{M}, d_{Y}, d_{K}, d_{lc}, dₗₘ) with respect to a plurality of representative coordinates in the color space. The CSM P3b3 acquires the ink amount set φ corresponding to the RGB value of the pixel with reference to the 3D-LUT. At this time, with respect to the RGB values that are not explicitly described in the 3D-LUT, the corresponding ink amount set φ is acquired by performing interpolation. In addition, as a method of generating the 3D-LUT, Patent Document JP-A-2006-82460 or the like may be employed. In the Patent Documents, a 3D-LUT capable of collectively improving color reproducibility in a specific light source, a gradation property of a reproduced color, a granularity, a light source independence of a reproduced color, a gamut, or an ink duty is generated.

On the other hand, in the case where the flag denoting that the index is stored in the selected pixel is determined to be set up in the step S330, in the step S350, the ISM P3b2 performs the color conversion (separation) on the pixel with reference to the 1D-LUT. In other words, the index can be acquired from the pixel where the flag denoting that the index is stored therein is set up, and the ink amount set φ corresponding to the index in the 1D-LUT can be acquired. If the ink amount set φ with respect to the pixel can be acquired in the step S340 or the step S350, it is determined in the step S360 whether or not the ink amount set φ can be obtained with respect to all the pixels. At this time, in the case where any pixel where the ink amount set φ is not acquired remains, the process returns to the step S320 to select the next pixel.

By repeatedly executing the above process, the ink amount set φ can be acquired with respect to all the pixels. If the ink amount set φ can be acquired with respect to all the pixels, it can be stated that all the pixels are converted to the printing data PD represented by the ink amount set φ. In this manner, by determining whether or not any one of the 1D-LUT and the 3D-LUT is used for each pixel, it is possible to acquire the ink amount set φ by which the color similar to each of the targets TG1 to TG12 in each light source can be reproduced with respect to the pixels corresponding to the panes F1 to F12 in which the indexes are stored, and it is possible to acquire the ink amount set φ by which the color can be reproduced based on the 3D-LUT generation guideline (for example, the granularity is emphasized) with respect to the pixels in which the RGB values are stored.

In the step S370, the HTM P3b4 acquires the printing data PD that represents each pixel with the ink amount set φ and executes a halftone process. The HTM P3b4 can use the well-known dither method, error diffusion method, or the like in the halftone process. The printing data PD of which the halftone process is completed have the ejection signal indicating whether or not each pixel ejects ink. In the step S380, the RTM P3b5 acquires the printing data PD of which the halftone process is completed, and a process of allocating the ejection signal in the printing data PD to each scan path and each nozzle in a print head included in the printer 20 is executed. Therefore, the printing control data CD that can be output to the printer 20 can be generated, and the printing control data CD that are attached with the signals needed to control the printer 20 are output to the spooler P1b and the printer 20. As a result, the printer 20 ejects the ink on the printing sheet to form the sample chart SC.

Accordingly, in the region corresponding to the panes FL1 to FL12 of the sample chart SC formed on the printing sheet, the target spectral reflectance Rₜ(λ) of each of the targets TG1 to TG12 can be reproduced. In other words, since the region corresponding to the panes FL1 to FL12 is printed with the ink amount set φ according to the colors of the targets TG1 to TG12 under a plurality of light sources, the colors similar to the targets TG1 to TG12 under each light source can be reproduced. For example, the color of the region corresponding to each of the panes FL1 to FL12 at the time when the sample chart SC is perceived with eyes inside a room can reproduce the color at the time when each of the targets TG1 to TG12 is perceived with eyes inside the room. In addition, the color of the region corresponding to each of the panes FL1 to FL12 at the time when the sample chart SC is perceived with eyes outside the room can also reproduce the color at the time when each of the targets TG1 to TG12 is perceived with eyes outside the room.

In addition, consequently, if the sample chart SC having completely the same spectral reflectances R(λ) as the targets TG1 to TG12 is reproduced, the same colors as the targets TG1 to TG12 in any light sources can be reproduced. However, since the ink (kinds of color materials) available to the printer 20 is limited to CMYKlclm, it is practically impossible to obtain the ink amount set φ by which completely the same spectral reflectance R(λ) as the targets TG1 to TG12 can be reproduced. In addition, although the ink amount set φ by which the same spectral reflectances R(λ) as the targets TG1 to TG12 can be reproduced is obtained in the wavelength range where there is no influence on the perceived color, it is not necessary to implement a visual reproduction accuracy. Therefore, in the invention, since the approximation to the target spectral reflectance Rₜ(λ) is evaluated by using the evaluated value E(φ) obtained by performing the weighting based on the color matching functions x(λ), y(λ), and z(λ), it is possible to obtain the ink amount set φ capable of implementing sufficient visual accuracy.

On the other hand, in the region corresponding to the panes FL1 to FL12 of the sample chart SC formed on the printing sheet, the printing is performed by using the ink amount set φ based on the aforementioned 3D-LUT. Therefore, the printing performance in the region is based on the 3D-LUT. As described above, in the embodiment, although the region outside the panes FL1 to FL12 represents the image having constant intermediate gray, the printing performance as a goal of the 3D-LUT in the region can be satisfied. In other words, it is possible to implement the printing capable of collectively improving a gradation property of a reproduced color, a granularity, a light source independence of a reproduced color, a gamut, or an ink duty.

### 4. Calibration Process

With respect to the panes FL1 to FL12 of the sample chart SC that is printed according to the above process, the target spectral reflectances Rₜ(λ) of the targets TG1 to TG12 can be reproduced.

However, in some cases, there may be an error between the actual spectral reflectances R(λ) of the panes FL1 to FL12 of the sample chart SC and the target spectral reflectances Rₜ(λ) of the targets TG1 to TG12. Since the ink amount set φ is predicted by the RPM P3a2 using a prediction model (spectral printing model), in the case where the matching of the printer where the spectral printing model is implemented (spectral reflectance database RDB is generated) is different from the machine of the printer 20 that actually performs the printing or the case where the same machines are different in terms of time, the occurrence of errors is inevitable.

Therefore, in the calibration process, in order to further improve the reproducibility of the target spectral reflectance Rₜ(λ), a process of checking whether or not the panes FL1 to FL12 of the sample chart SC actually reproduces the target spectral reflectance Rₜ(λ) approximate to the targets TG1 to TG12 is performed.

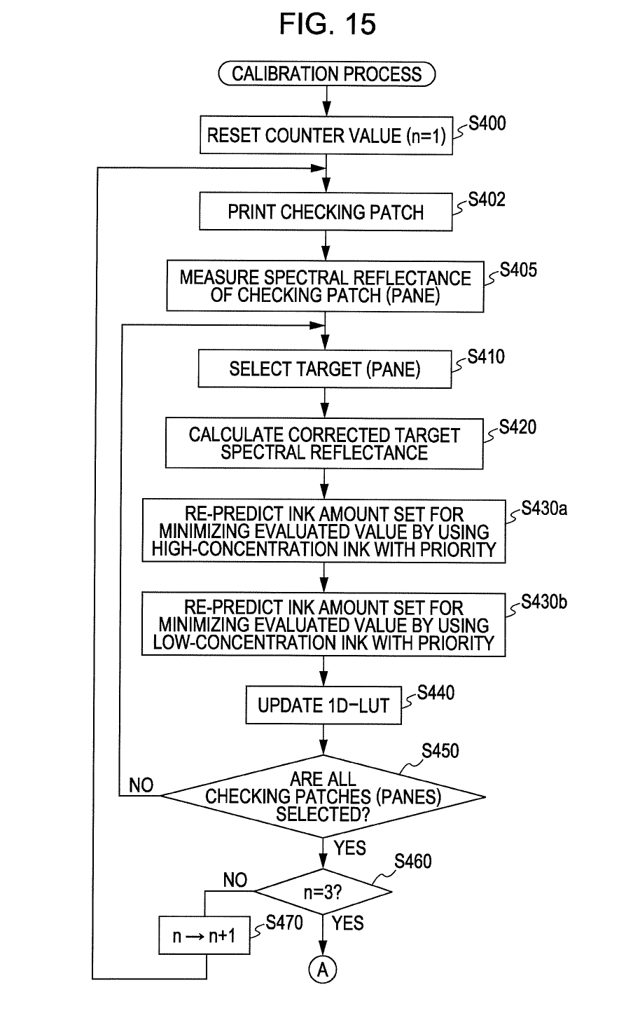

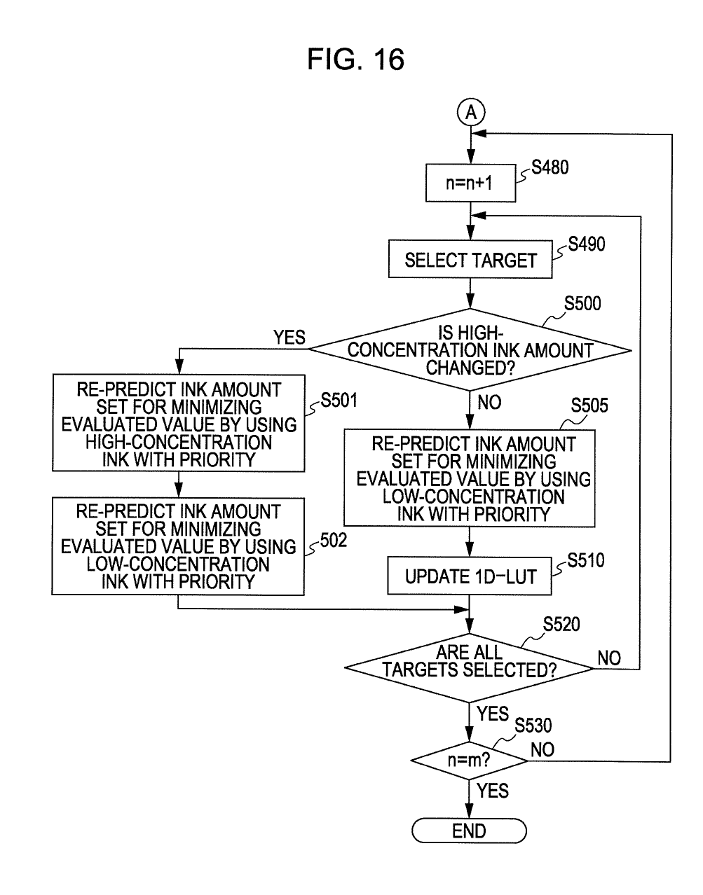

FIGS. 15 and 16 show a flowchart of the calibration process. As shown in FIG. 2, the LUG P3a that is a module for performing the calibration process includes a checking patch measurement unit (KPM) P3a5 and a corrected target value acquisition unit (MRA) P3a6.

If the process starts, in the step S400, a counter value (n) indicating the number of repetitions of the calibration process is reset to 1.

In the step S405, the spectral reflectances R(λ) with respect to the panes FL1 to FL12 of the previously printed sample chart SC are measured. Herein, the MDV P4 controls the spectral reflectometer 30 in response to the request of the KPM P3a5, and the spectral reflectance data RD obtained through the control is acquired by the KPM P3a5. In addition, the panes FL1 to FL12 of the sample chart SC of which spectral reflectances R(λ) are measured correspond to the checking patches according to the invention. In addition, the spectral reflectance R(λ) obtained by performing colorimetry on the checking patch is referred to as a checked spectral reflectance R_{c}(λ). According to the aforementioned printing control process, the target spectral reflectances Rₜ(λ) measured from the targets TG1 to TG12 and the checked spectral reflectances R_{c}(λ) measured in the step S405 are ideally equal to each other. However, as described above, since errors may occur, it cannot be stated that the target spectral reflectances Rₜ(λ) and the checked spectral reflectances R_{c}(λ) are completely equal to each other.

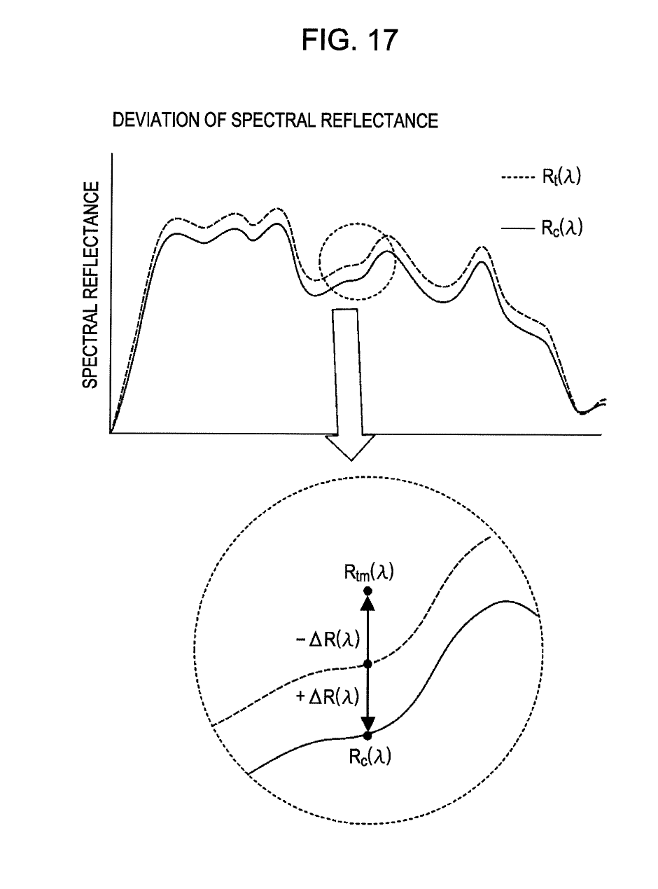

FIG. 17 shows a comparison of the target spectral reflectance Rₜ(λ) and the checked spectral reflectance R_{c}(λ) with respect to the target TG1 (pane FL1). As shown in the figure, the checked spectral reflectance R_{c}(λ) mostly follows the target spectral reflectance Rₜ(λ), but the checked spectral reflectance R_{c}(λ) is shifted toward the low reflectance on the whole. For example, in the case where the ink amount of each ink ejected by the printer 20 is increased according to the passing of time, the checked spectral reflectance R_{c}(λ) is shifted toward the low reflectance on the whole.

In the step S410, the corrected target value acquisition unit (MRA) P3a6 selects the targets TG1 to TG12 (panes FL1 to FL12). In the step S420, the deviation ΔR(λ) with respect to each wavelength can be calculated by subtracting target spectral reflectance Rₜ(λ) from the checked spectral reflectance R_{c}(λ) with respect to the selected Target TG. In addition, the target spectral reflectance Rₜ(λ) can be obtained from the index table IDB.

In addition, in the step S420, the MRA P3a6 calculates the corrected target spectral reflectance Rₜₘ(λ)={Rₜ(λ)−ΔR(λ)} by subtracting the deviation ΔR(λ) from the target spectral reflectance Rₜ(λ).

In this manner, if the corrected target spectral reflectance Rₜₘ(λ) is obtained, in the step S430a and the step S430b, the ICM P3a1 performs a process of calculating the ink amount set by which the same spectral reflectance R(λ) as the corrected target spectral reflectance Rₜₘ(λ) can be reproduced by using the RPM P3a2 and the ECM P3a3. However, unlike the above step S230, the optimal solution of the ink amount set φ is calculated by separately using a process of calculating the ink amount set by using the high-concentration ink with priority (by suppressing the used amount of the low-concentration ink) and a process of calculating the ink amount set by using the low-concentration ink with priority (by suppressing the used amount of the high-concentration ink). For this reason, the ink set is divided into a high-concentration ink group and a low-concentration ink group based on the ink concentration. In the step S430a, the ink amount set is calculated so that the ink of the high-concentration ink group can be allocated with priority, and in the step S430b, the ink amount set is calculated so that the ink of the low-concentration ink group can be allocated with priority.

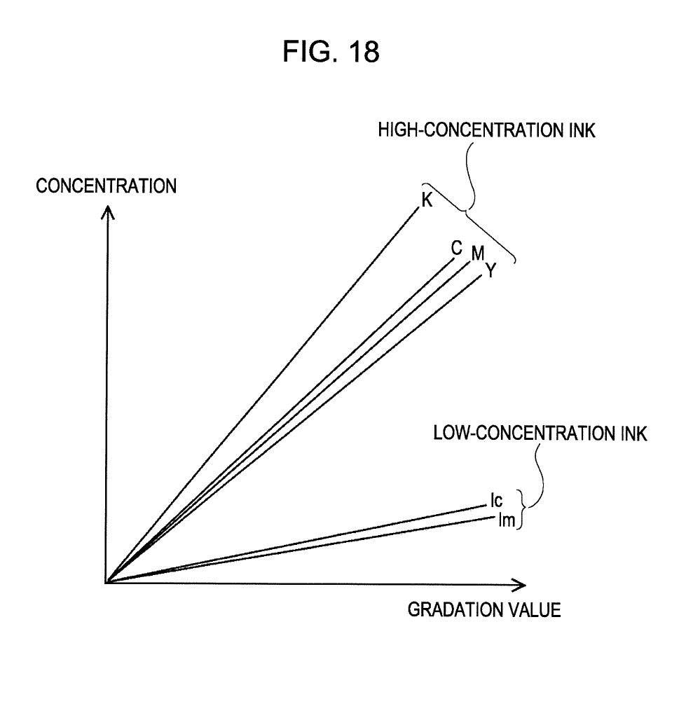

Now, the difference between the high-concentration ink and the low-concentration ink is described with reference to FIG. 18. The figure is a graph showing a change in concentration according to a change in the gradation value of each of the high-concentration ink and low-concentration ink. Comparing the high-concentration ink and the low-concentration ink, the concentration of the high-concentration ink is relatively higher than the concentration of the low-concentration ink, and the high-concentration ink causes a larger change in the amount of the color value occurring in the recording medium at the time when the same amounts of the two inks are fixed on the recording medium. For example, in the case where the ink concentration of each ink is represented by 256 gradations, if the concentration of the high-concentration ink is three times larger than that of the low-concentration ink, the change in concentration for one gradation in the high-concentration ink corresponds to the change in concentration for three gradations in the low-concentration ink. More specifically, for example, in the case where the ink set is configured with CMYKlclm, the CMYK inks are the high-concentration inks, and the lclm inks are low-concentration inks. Needless to say, in the case where the ink set includes light yellow, light black, or the like, these inks are the low-concentration inks. Therefore, taking into consideration a limitation on the ink landing amount (the total ink amount that can be fixed to a unit area), in order to determine the ink set for reproducing a color, the high-concentration ink is preferable to be used with priority.

However, on the contrary, since the change in the amount of concentration that occurs in the recording medium at the time when the same amounts of the low-concentration inks are fixed, is relatively small, a difference of dense concentrations of the low-concentration inks can be represented. If one gradation in the high-concentration ink corresponds to three gradations of the low-concentration ink, the low-concentration ink can represent the difference in the concentrations that is 3 times finer than that of the high-concentration ink. In other words, the low-concentration ink has a higher concentration resolution than the high-concentration ink. According to the above characteristics of the high-concentration ink and the low-concentration ink, it is preferable that, in the ink set for reproducing a color, the high-concentration ink having a low concentration resolution is allocated with priority, and after that, fine adjustment is performed by using the low-concentration ink having a high concentration resolution.

In addition, in the embodiment, the ink set is configured to be divided into the high-concentration ink group and the low-concentration ink group. In the embodiment, the high-concentration ink group is configured with the C ink, the M ink, the K ink, and the low-concentration ink group is configured with the Y ink, the lc ink, and the lm ink. Although the Y ink is an ink having a high concentration, in the embodiment, the Y ink is designed to be included in the low-concentration ink group. In the case of the ink set of CMYKlclm, although any division method may be used, only one yellow color exists in the yellow direction. Therefore, even in the case where the ink amount set is predicted while only the ink included in the low-concentration ink group is changed, non-uniformity of hue cannot easily occur. Moreover, if the ink set includes a low-concentration ink such as ly (light yellow) ink of which a change in the amount in the brightness direction can easily occur, only the ink concentrations are simply considered, so that the high-concentration ink group can be configured with CMYK, and the low-concentration ink group is configured with lclmly.

In addition, in the process of calculating the ink amount set according to the embodiment, the optimal solution is sought while the ink amount is changed by an amount smaller than the minimum ink amount that can be ejected on the printing sheet in the printer 20. For example, if the 256 gradations can be represented by the printer 20 changing the ejection amount of the ink, the optimal ink amount set is sought while the gradation is changed in units of 0.01 gradation. In this manner, the seeking step is designed to be small, the vibration in the vicinity of the optimal solution can be suppressed, so that it is possible to easily find the optimal solution. However, before the ink amount is actually set up, the number of digits after the decimal point in the ink amount undergoes a number rounding process, so that a rounding error occurs. In the embodiment described later, the influence of the rounding error can be minimized. In addition, in the description hereinafter, the number that uses the minimum ejectable ink amount as a unit amount is referred to as an integer value, and the number that is smaller than the unit amount is referred to as a fractional value.

In the step S430a, an optimization process of changing the high-concentration ink set with priority is executed. More specifically, the optimization process of changing the high-concentration ink set with priority can be implemented by using the following target function.

$$\begin{matrix}Equation 4 & \\ E ( φ ) = \sqrt{\frac{\sum {\{ w ( λ ) D ( λ ) \}}^{2}}{N}} \\ D ( λ ) = {R}_{tm} ( λ ) - R ( λ ) & ( 4 )\end{matrix}$$

In other words, the function that is obtained by replacing the target spectral reflectance Rₜ(λ) of the evaluated value E(φ) expressed in the above Equation 4 with the corrected target spectral reflectance Rₜₘ(λ) is used as a target function, and the optimal solution of the ink amount set φ capable of minimizing the target function is calculated. With respect to the target function, although the weighting is not performed for every ink group, the high-concentration ink capable of greatly decreasing the target function at the time when only the same amounts of the high-concentration ink and the low-concentration ink are changed is used with priority until the vicinity of the optimal solution is reached. Needless to say, a term that interferes with the change in the ink amount of the low-concentration ink set may be added to the target function (for example, a term that is decreased according to the change in the ink amount of the high-concentration ink set may be added to the target function or a term that is increased according to the change in the ink amount of the low-concentration ink set may be added to the target function). If the optimal solution of the ink amount set φ is calculated, the number rounding process of the ink amount set φ is performed.

In the number rounding process, the number of digits after the decimal point may be rounded and the rounding error from the optimal solution occurs in the ink amount set after the number rounding process. In the case where the same amounts of the rounding errors occur in the ink amount of the high-concentration ink and the ink amount of the low-concentration ink, the influence on the color that is reproduced by the high-concentration ink is larger. For example, the change in concentration in the case where the 0.5 gradation of the high-concentration ink is rounded corresponds to the change in concentration corresponding to the 1.5 gradation of the low-concentration ink. In other words, the change in concentration that is rounded as a fractional number of the high-concentration ink can be represented as an integer number of the low-concentration ink. Accordingly, in order to obtain the ink amount set further approximated to the optimal solution, the amount of the error is to be constructively represented in the ink amount of the low-concentration ink.

Therefore, in the step S430b, an optimization process of changing the low-concentration ink set with priority by using the ink amount set after the number rounding process calculated in the step S430a as an initial condition is performed. Needless to say, as well as performing with priority, it is possible to change only the low-concentration ink set with the high-concentration ink set completely unchanged. More specifically, the optimization process of changing the low-concentration ink set with priority is implemented by using the following target function.

$$\begin{matrix}Equation 5 & \\ E ( φ ) = \sqrt{\frac{\sum {\{ w ( λ ) D ( λ ) \}}^{2}}{N}} + {w}_{C} \cdot Δ C + {w}_{M} \cdot Δ M + {w}_{K} \cdot Δ K \\ D ( λ ) = {R}_{tm} ( λ ) - R ( λ ) \\ {w}_{C} , {w}_{M} , {w}_{K} \text{:} weighting factor \\ Δ C \text{:} changed amount of cyan ink \\ Δ M \text{:} changed amount of magenta ink \\ Δ K \text{:} changed amount of black ink & ( 5 )\end{matrix}$$

In the above Equation 5, ΔC, ΔM, and ΔK denote experimentally changed amounts of the cyan, magenta, and black inks at the time of determining whether or not the target function is decreased in the optimization process. In addition, w_{C}, w_{M}, and w_{K} denote weighting factors for the cyan, magenta, and black inks. By using the target function of the above Equation 5, the target function is increased in the experimental change of the CMK inks, so that the change thereof can be interfered with. In other words, if the first term of the target function is not decreased beyond the erasing of the increase in the target function caused from the weighted terms of the target function, the optimization of the change in the CMK inks can be interfered with. Therefore, the optimization process of changing the low-concentration ink set with priority to the high-concentration ink set is implemented. The number rounding process is performed on the optimal solution of the ink amount set φ that is calculated in the above method. In the number rounding process, the rounding error occurs mainly in the low-concentration ink set. Therefore, the rounding errors occurring before and after the number rounding process are smaller than the rounding error occurring in the step S430.

In the step S440, the LUT output module (LOM) P3a4 updates the ink amount set φ with respect to the index corresponding to the 1D-LUT with the optimized ink amount set φ. If the ink amount set φ is updated, it is determined in the step S450 whether or not all the targets TG1 to TG12 (panes FL1 to FL12) are selected. If not selected, in the step S420, the next targets TG1 to TG12 (panes FL1 to FL12) are selected. As a result, with respect to all the targets TG1 to TG12, the ink amount set φ can be updated. In this manner, by updating the 1D-LUT, in the printing control data generation process that is executed later, the printing of the sample chart SC can be performed based on the updated ink amount set φ.

In this manner, by executing the calibration process, reproduction of the spectral reflectance R(λ) at a higher accuracy can be implemented. For example, in the case where the checked spectral reflectance R_{c}(λ) is larger than the target spectral reflectance Rₜ(λ), since the deviation ΔR(λ) between the checked spectral reflectance R_{c}(λ) and the target spectral reflectance Rₜ(λ) is subtracted from the original target spectral reflectance Rₜ(λ), the corrected target spectral reflectance Rₜₘ(λ) has a value smaller than the original target spectral reflectance Rₜ(λ). Therefore, according to the ink amount set φ optimized by using the corrected target spectral reflectance Rₜₘ(λ), the reproduced spectral reflectance R(λ) can be downwardly corrected according to the magnitude of the deviation ΔR(λ). On the contrary, in the case where the checked spectral reflectance R_{c}(λ) is smaller than the target spectral reflectance Rₜ(λ), since the corrected target spectral reflectance Rₜₘ(λ) is considered to be larger than the original target spectral reflectance Rₜ(λ), the reproduced spectral reflectance R(λ) can be upwardly corrected according to the magnitude of the deviation ΔR(λ).

In addition, in the embodiment, by repeatedly executing the above calibration process, reproduction of the spectral reflectance R(λ) at a higher accuracy can be implemented. In the step S460, it is determined whether or not the counter value n indicating the number of repetitions of the calibration process is 3. If not 3, 1 is added to the counter value n (step S470), and the process returns to the step S402. As a result, the printing of the checking patch in the step S402 is performed again. Herein, since the printing of the checking patch is performed based on the ink amount set φ updated in the first calibration process, the absolute value of the deviation ΔR(λ) between the target spectral reflectance Rₜ(λ) and the checked spectral reflectance R_{c}(λ) is predicted to decrease in comparison to that of the pervious time. In the step S420, with respect to a new checked spectral reflectance R_{c}(λ), the corrected target spectral reflectance Rₜₘ(λ)={Rₜ(λ)−ΔR(λ)} is set up. In the steps S430 to S440, the ink amount set can be updated with the ink amount set φ capable of further erasing the decreased deviation ΔR(λ). Since the calibration process is repeated until the counter value n becomes 3, the absolute value of the deviation ΔR(λ) in the time interval can be minimized, so that the reproduction of the spectral reflectance at a higher accuracy can be implemented.

In addition, although the deviation ΔR(λ) is subtracted from the original target spectral reflectance Rₜ(λ) in the above embodiment, about 80% of the deviation ΔR(λ) may be subtracted. In addition, the number of repetitions is not limited to 3. The calibration process is preferably executed in the case where the printer 20 of the same machine is not used for a long time or the case where the sample chart SC is printed in the printer of the other machine.

As described above, although the ink amount set φ is obtained by performing the optimization process two times while performing the printing of the checking patch and the colorimetry of the checking patch in the calibration process of the steps S400 to S460, in order to further improve the accuracy of the calculation, the optimization process without the printing of the patch and the colorimetry of the patch may be repeatedly executed several times. In this case, in the steps S480 to S530, the optimization process for improving the accuracy of the calibration is executed by using the result of the preceding colorimetry (the result of the colorimetry in the step S405 in the loop at the time when the condition of the step S460 is satisfied).

If the condition of the step S460 is satisfied, 1 is added to the counter value n in the step S480, the process proceeds to the step S490.

In the step S490, the corrected target value acquisition unit (MRA) P3a6 selects the targets TG1 to TG12 (panes FL1 to FL12). This is the same as that of the step S420.

In the step S500, by comparing the ink amount set φn−1 of the 1D-LUT updated at the time when the counter n is n−1 with the ink amount set φn−2 of the 1D-LUT updated at the time when the counter n is n−2, it is determined whether or not there is a change in the ink amount of the high-concentration ink group. If there is a change, the condition is satisfied, the process proceeds to the step S501, so that the optimization of treating the high-concentration ink group with priority and the optimization of treating the low-concentration ink group with priority are sequentially executed. If there is no change, the condition is not satisfied, the process proceeds to the step S505, so that only the optimization of treating the low-concentration ink group with priority is executed. This is because, if the ink amount sets of the high-concentration ink group having a low resolution are two times consecutively optimized to the same value, the value is considered to be the optimal solution. In addition, in order to compare the ink amount set φn−1 with the ink amount set φn−2, the 1D-LUT of the recent two times are temporarily stored in the RAM.

In the step S501, the same optimization process as the step S430a is performed by using the ink amount set in the 1D-LUT generated at the time when the counter value is n−1 as an initial value. In the step S502, the same optimization process as the step S430b is performed. In the step S505, the same optimization process as the step S430b is performed by using the ink amount set in the 1D-LUT at the time when the counter value is n−1 as an initial value.

In the step S510, the LUT output module (LOM) P3a4 updates the ink amount set φ with respect to the index corresponding to the 1D-LUT with the ink amount set φ optimized in the step S502 or S505.

In the step S520, it is determined whether or not all the targets TG1 to TG12 (panes FL1 to FL12) are selected. If not selected, in the step S490, the next targets TG1 to TG12 (panes FL1 to FL12) are selected. As a result, with respect to all the targets TG1 to TG12, the ink amount set φ can be updated.

In the step S530, it is determined whether or not the counter n indicating the number of repetitions of the calibration process is m (m is an integer of 4 or greater). If not m, 1 is added to the counter value n (step S480), and the process after the step S490 is repeated. If the counter value reaches m, it is determined that the optimization of predetermined loop times is ended, so that the calibration process is ended. In addition, the loop times may be set to, for example, a predetermined number of times performed after the ink amount of the high-concentration ink group is not changed.

### 5. Spectral Printing Model

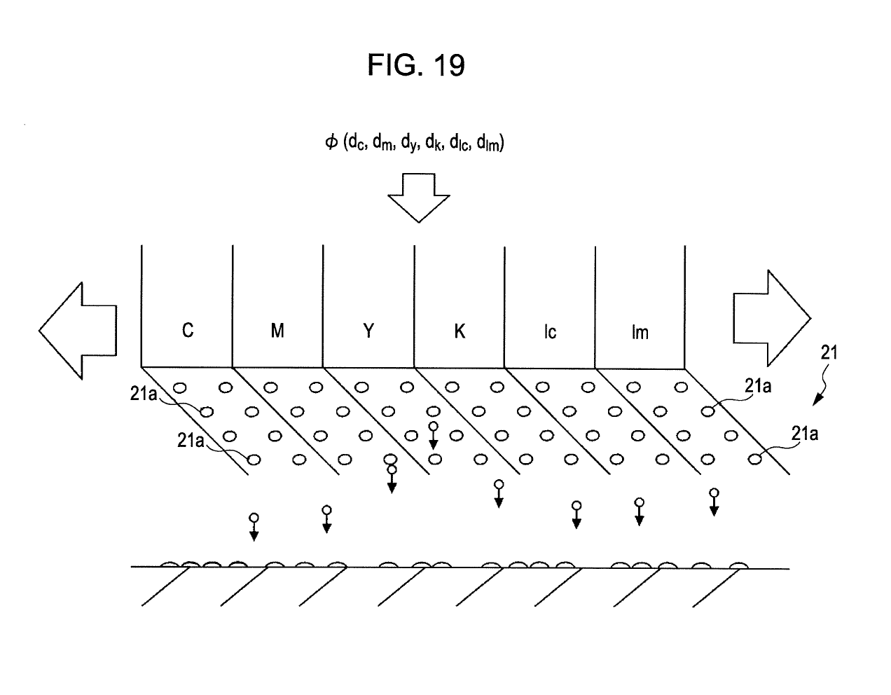

FIG. 19 diagrammatically shows the printing scheme of the printer 20 according to the embodiment. In the figure, the printer 20 includes a print head 21 having a plurality of the nozzles 21a, 21a . . . for each of the CMYKlclm inks. The control of setting the ink amount of each of the CMYKlclm inks ejected by the nozzles 21a, 21a . . . to the amount designated by the aforementioned ink amount set φ(d_{c}, dₘ, d_{y}, dₖ, d_{lc}, dₗₘ) is performed based on the printing control data CD. Ink droplets ejected by the nozzles 21a, 21a . . . become fine dots on the printing sheet, so that a printed image having an ink area coverage according to the ink amount set φ(d_{c}, dₘ, d_{y}, dₖ, d_{lc}, dₗₘ) is formed on the printing sheet by an accumulation of a plurality of the dots.

The prediction model (spectral printing model) used by the RPM P3a2, a prediction model for predicting the spectral reflectance R(λ) as the predicted spectral reflectance Rₛ(λ) in the case where the printing is performed by using an arbitrary ink amount set φ(d_{c}, dₘ, d_{y}, dₖ, d_{lc}, dₗₘ) that can be used in the printer 20 according to the embodiment. In the spectral printing model, the color patches are actually printed at a plurality of representative points in the ink amount space, and the spectral reflectance database RDB obtained by measuring the spectral reflectance R(λ) with a spectral reflectometer is prepared. Next, the prediction is performed based on the cellular Yule-Nielsen spectral Neugebauer model using the spectral reflectance database RDB, so that the spectral reflectance R(λ) in the case where the printing is performed by using an arbitrary ink amount set φ(d_{c}, dₘ, d_{y}, dₖ, d_{lc}, dₗₘ) is accurately predicted.

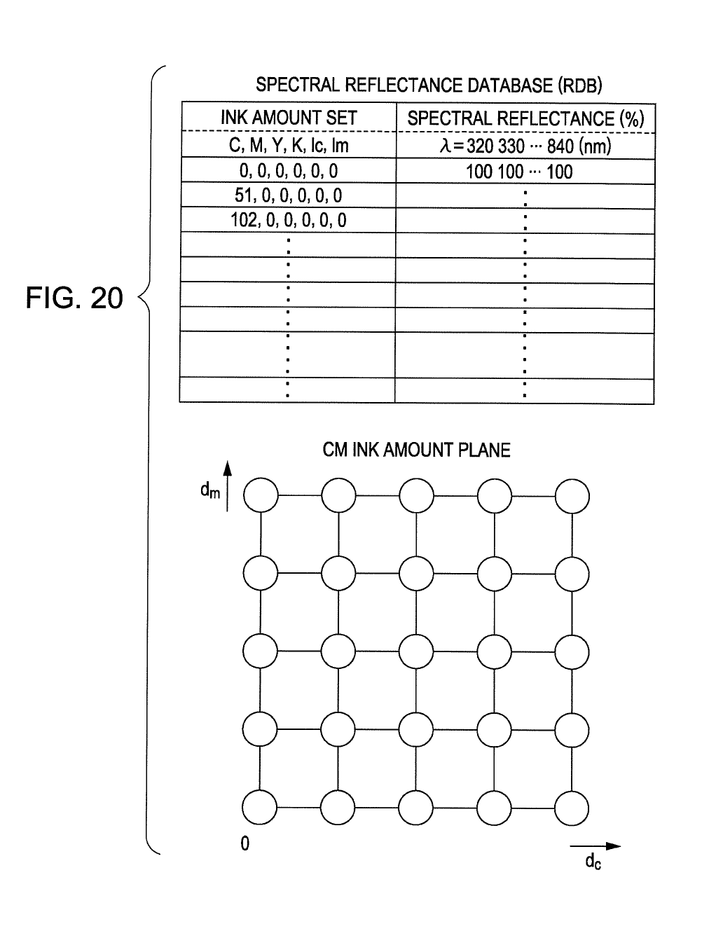

FIG. 20 shows the spectral reflectance database RDB. As shown in the figure, the spectral reflectance database RDB is a lookup table describing the spectral reflectances R(λ) that are obtained by actually performing the printing/measurement on the ink amount set φ(d_{c}, dₘ, d_{y}, dₖ, d_{lc}, dₗₘ) at a plurality of lattice points in the ink amount space (six dimensions in the embodiment, but only the CM plane is shown in order to simplify the figure). For example, 5 grids of lattice points for dividing each ink amount axis are generated. Herein, 5¹³ lattice points are generated and a large amount of color patches need to be printed/measured. However, in reality, since there is a limitation to the number of inks that can be simultaneously mounted in the printer 20 or an ink duty that can be simultaneously ejected, the number of lattice points for printing/measurement can be reduced.

In addition, the actual printing/measuring is performed only on some of lattice points, and on other remaining lattice points, the spectral reflectance R(λ) is predicted on the basis of the spectral reflectance R(λ) of the lattice points on which the actual printing/measurement is performed, so that the number of color patches on which the actual printing/measurement is performed can be reduced. The spectral reflectance database RDB needs to be prepared for every printing sheet on which the printer 20 can perform the printing. Strictly speaking, this is because the spectral reflectance R(λ) is defined by a spectral transmittance due to the ink layer (dots) formed on the printing sheet and a reflectance of the printing sheet, so that the spectral reflectance is greatly influenced by the surface physical properties (dependence of the shape of dots) of the printing sheet or the reflectance. Next, the prediction according to the cellular Yule-Nielsen spectral Neugebauer model using the spectral reflectance database RDB is described.

The RPM P3a2 performs the prediction according to the cellular Yule-Nielsen spectral Neugebauer model using the spectral reflectance database RDB in response to the request of the ICM P3a1. In the prediction, a prediction condition is acquired from the ICM P3a1, and the prediction condition is set up. More specifically, the printing sheet or the ink amount set φ is set to the printing condition. For example, in the case where the prediction is performed by using a glossy paper as the printing sheet, the spectral reflectance database RDB generated by printing the color patches on the glossy paper is set up.

If the spectral reflectance database RDB can be set up, the ink amount set φ(d_{c}, dₘ, d_{y}, dₖ, d_{lc}, dₗₘ) input from the ICM P3a1 is applied to the spectral printing model. The cellular Yule-Nielsen spectral Neugebauer model is based on the well-known spectral Neugebauer model and Yule-Nielsen model. In addition, in the description hereinafter, the model of the case where the three kinds of inks (that is, CMY inks) are used is described in order to simplify the description. However, the model can be easily expanded to the model using an arbitrary ink set including the CMYKlclm inks according to the embodiment. In addition, with respect to the cellular Yule-Nielsen spectral Neugebauer model, Color Res. Appl. 25, 4-19, 2000 and R Balasubramanian, Optimization of the spectral Neugebauer model for printer characterization, J. Electronic Imaging 8 (2), 156-166 (1999) can be referred to.

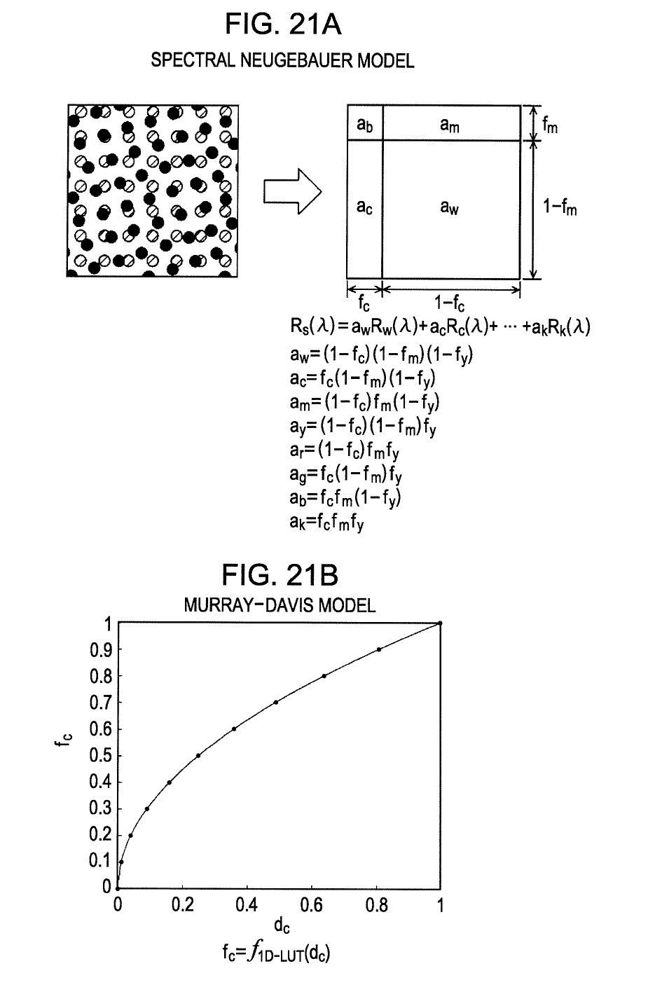

FIG. 21 is a view showing the spectral Neugebauer model. In the spectral Neugebauer model, the predicted spectral reflectance Rₛ(λ) of a printing material at the time when the printing is performed by using an arbitrary ink amount set φ(d_{c}, dₘ, d_{y}) is expressed by the following Equation 6.

Equation 6

Rₛ(λ)=a_{w}R_{w}(λ)+a_{c}R_{c}(λ)+aₘRₘ(λ)+a_{y}R_{y}(λ)+aᵣRᵣ(λ)+a_{g}R_{g}(λ)+a_{b}R_{b}(λ)+aₖRₖ(λ)

a_{w}=(1−f_{c})(1−fₘ)(1−f_{y})

a_{w}=(1−f_{c})(1−fₘ)(1−f_{y})

a_{c}=f_{c}(1−fₘ)(1−f_{y})

aₘ=(1−f_{c})fₘ(1−f_{y})

a_{y}=(1−f_{c})(1−fₘ)f_{y}

aᵣ=(1−f_{c})fₘf_{y}

a_{g}=f_{c}(1−fₘ)f_{y}

a_{b}=f_{c}fₘ(1−f_{y})

aₖ=f_{c}fₘf_{y} (6)

Herein, aᵢ denotes an area ratio of the i-th area, and Rᵢ(λ) denotes a spectral reflectance of the i-th area. The subscripts i denote an area (w) where there is no ink, an area (c) where there is only the cyan ink, an area (m) where there is only the magenta ink, an area (y) where there is only the yellow ink, an area (r) where the magenta ink and the yellow ink are ejected, an area (g) where the yellow ink and the cyan ink are ejected, an area (b) where the cyan ink and the magenta ink are ejected, and an area (k) where the three inks, that is, CMY inks are ejected, respectively. In addition, f_{c}, fₘ, and f_{y} denote a ratio (referred to as an ink area coverage) of an area which is covered with an ink in the case where one kind of ink among the CMY inks is ejected.

The ink area coverages f_{c}, fₘ, and f_{y} are given by the Murray-Davis model shown in FIG. 21B. In the Murray-Davis model, for example, the ink area coverage f_{c} of the cyan ink is a non-linear function of the cyan ink amount d_{c}. For example, the ink amount d_{c} can be reduced to the ink area coverage f_{c} by using a one-dimensional lookup table. The reason why the ink area coverages f_{c}, fₘ, and f_{y} become non-linear functions of the ink amounts d_{c}, dₘ, and d_{y} is as follows. In the case where a small amount of ink is ejected in a unit area, the ink can be spread sufficiently. However, in the case where a large amount of inks are ejected, the inks are overlapped with each other, so that the area that is covered with the inks is not greatly increased. With respect to the other kinds of inks, that is, the MY inks, the same description can be made.

By applying the Yule-Nielsen model to the spectral reflectance, the above Equation 6 can be changed into the following Equation 7a or 7b.

Equation 7a

Rₛ(λ)^{1/n}=a_{w}R_{w}(λ)^{1/n}+a_{c}R_{c}(λ)^{1/n}+aₘRₘ(λ)^{1/n}+a_{y}R_{y}(λ)^{1/n}+aᵣRᵣ(λ)^{1/n}+a_{g}R_{g}(λ)^{1/n}+a_{b}R_{b}(λ)^{1/n}+aₖRₖ(λ)^{1/n} (7a)

Equation 7b

Rₛ(λ)={a_{w}R_{w}(λ)^{1/n}+a_{c}R_{c}(λ)^{1/n}+aₘRₘ(λ)^{1/n}+a_{y}R_{y}(λ)^{1/n}+aᵣRᵣ(λ)^{1/n}+a_{g}R_{g}(λ)^{1/n}+a_{b}R_{b}(λ)^{1/n}+aₖRₖ(λ)^{1/n}}ⁿ (7b)

Herein, n is a predetermined coefficient of 1 or more, and for example, the n can be set to n=10. The above Equations 7a and 7b are the equations expressing the Yule-Nielsen spectral Neugebauer model.

The cellular Yule-Nielsen spectral Neugebauer model that is adapted in the embodiment is obtained by dividing the ink amount space of the aforementioned Yule-Nielsen spectral Neugebauer model into a plurality of cells.

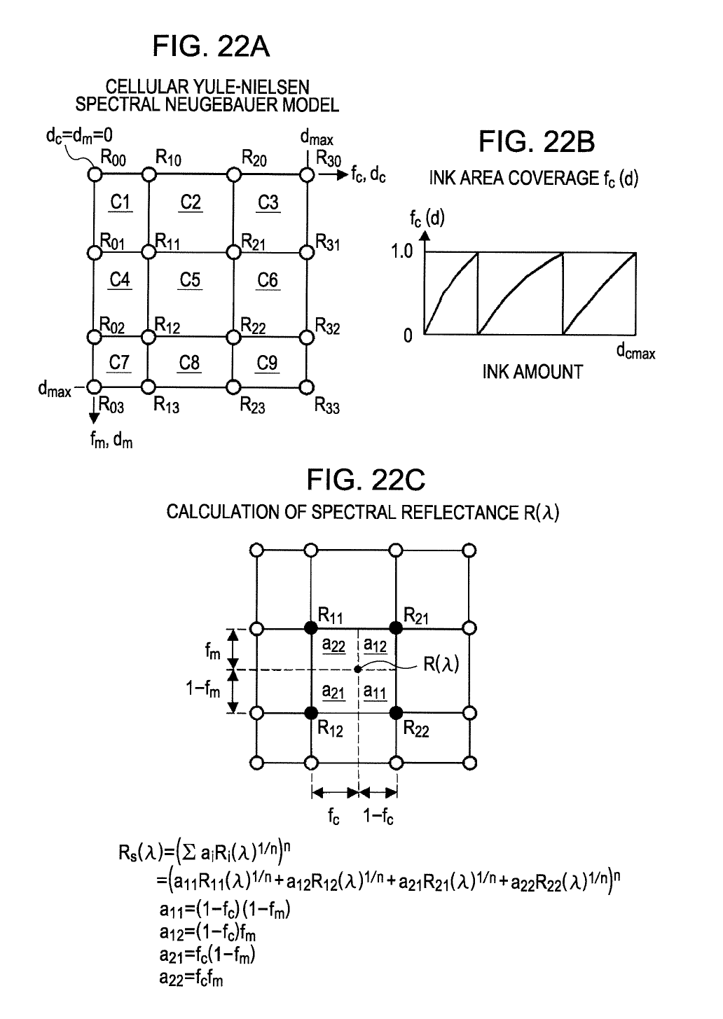

FIG. 22A shows an example of cell division in the cellular Yule-Nielsen spectral Neugebauer model. Herein, for simplifying the description, the cell division in a two-dimensional ink amount space having two axes of the ink amounts d_{c} and dₘ of the CM inks is shown. In addition, since the ink area coverages f_{c} and fₘ have one-to-one correspondence to the ink amounts d_{c} and dₘ in the aforementioned Murray-Davis model, the two axes may be considered to be the axes representing the ink area coverages f_{c} and fₘ. White circles are called grid points (referred to as lattice points) of the cell division, and the two-dimensional ink amount (area coverage) space is divided into 9 cells C1 to C9. The ink amount set (d_{c}, dₘ) corresponding to each lattice point becomes the ink amount set corresponding to the lattice point defined in the spectral reflectance database RDB. In other words, by referring to the aforementioned spectral reflectance database RDB, the spectral reflectance R(λ) of each lattice point can be obtained. Therefore, spectral reflectances R(λ)₀₀, R(λ)₁₀, R(λ)₂₀, . . . , and R(λ)₃₃ of the lattice points can be acquired from the spectral reflectance database RDB.

Actually, in the embodiment, the cell division is performed in the six-dimensional ink amount space of the CMYKlclm inks, and the coordinates of the lattice points are also represented by the six-dimensional ink amount set φ(d_{c}, dₘ, d_{y}, dₖ, d_{lc}, dₗₘ). Therefore, the spectral reflectances R(λ) of the lattice points corresponding to the ink amount set φ(d_{c}, dₘ, d_{y}, dₖ, d_{lc}, dₗₘ) of the lattice points are acquired from the spectral reflectance database RDB (for example, the database for a glossy paper)

FIG. 22B shows a relationship between the ink area coverage f_{c} and the ink amount d_{c} that are used in the cell division model. Herein, the ink amount range of 0 to d_{cmax} of one kind of ink is divided into three sections. A virtual ink area coverage f_{c} used in the cell division model is obtained by a non-linear curve that is simply increased from 0 to 1 for each section. With respect to other inks, the similar ink area coverages fₘ and f_{y} are obtained.

FIG. 22C shows a method of calculating the predicted spectral reflectance Rₛ(λ) at the time when the printing is performed by using an arbitrary ink amount set φ(d_{c}, dₘ) in the central cell C5 of FIG. 22A. The spectral reflectance Rₛ(λ) in the case where the printing is performed by using the ink amount set φ(d_{c}, dₘ) is expressed by the following Equation 8.

Equation 8

Rₛ(λ)=(ΣaᵢRᵢ(λ)^{1/n})ⁿ=(a₁₁R₁₁(λ)^{1/n}+a₁₂R₁₂(λ)^{1/n}+a₂₁R₂₁(λ)^{1/n}+a₂₂R₂₂(λ)^{1/n})ⁿ

a₁₁=(1−f_{c})(1−fₘ)

a₁₂=(1−f_{c})fₘ

a₂₁=f_{c}(1−fₘ)

a₂₂=f_{c}fₘ (8)

Herein, the ink area coverages f_{c} and fₘ in Equation 8 are values given by the graph of FIG. 22B. In addition, the spectral reflectances R(λ)₁₁, R(λ)₁₂, R(λ)₂₁, and R(λ)₂₂ corresponding to the four lattice points surrounding the cell C5 can be acquired by referring to the spectral reflectance database RDB. Accordingly, all the values included in the right handed side of Equation 8 can be determined. As a result of the calculation, the predicted spectral reflectance Rₛ(λ) in the case where the printing is performed by using an arbitrary ink amount set φ(d_{c}, dₘ) can be calculated. By sequentially shifting the wavelength λ in the visible wavelength range, the predicted spectral reflectance Rₛ(λ) in the visible wavelength range can be obtained. By dividing the ink amount space into a plurality of cells, the predicted spectral reflectance Rₛ(λ) can be calculated at a higher accuracy in comparison to the case where the division is not performed. In this manner, the RPM P3a2 can predict the predicted spectral reflectance Rₛ(λ) in response to the request of the ICM P3a1.

### 6. Modified Examples

### 6-1. Modified Example 1

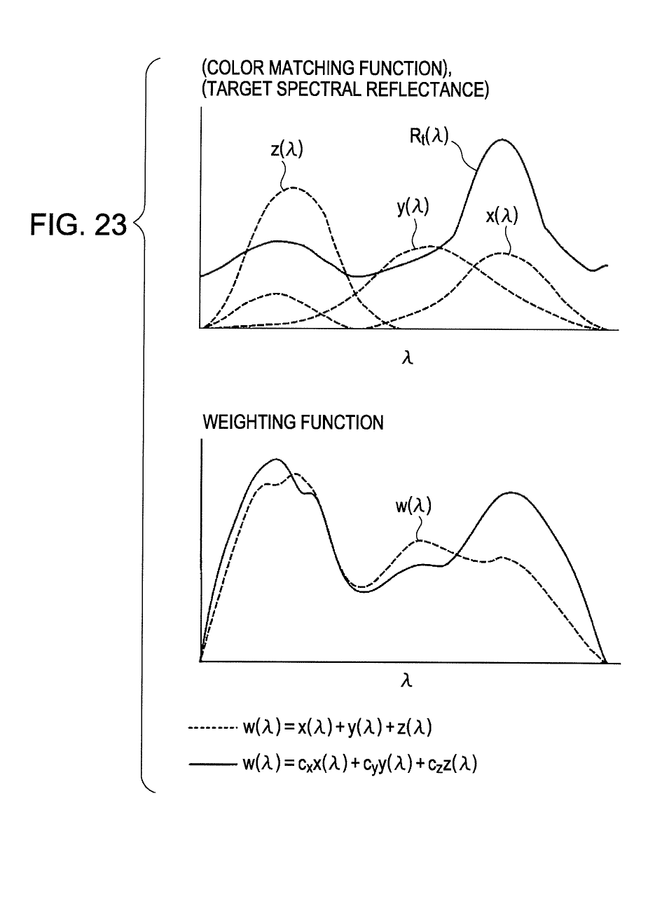

FIG. 23 diagrammatically shows the weighting function w(λ) that is set up by the ECM P3a3 in the modified example. In the figure, the target spectral reflectance Rₜ(λ) obtained from the target TG is shown, and correlation coefficients cₓ, c_{y}, and c_{z} between the target spectral reflectance Rₜ(λ) and the color matching functions x(λ), y(λ), and z(λ) are calculated by the ECM P3a3. In addition, the weighting function w(λ) according to the modified example is calculated by using the following Equation 9.

Equation 9

w(λ)=cₓx(λ)+c_{y}y(λ)+c_{z}z(λ) (9)

In the above Equation 9, in the color matching functions x(λ), y(λ), and z(λ)having a high correlation to the target spectral reflectance Rₜ(λ) obtained from the target TG, the weighting at the linear combination is designed to be increased. In the weighting function w(λ) obtained in the above method, the weighting in the wavelength range having a large target spectral reflectance Rₜ(λ) of the target TG can be emphasized. Therefore, the evaluated value E(φ) emphasizing the wavelength range where the spectrum of the spectral energy of the reflected light under each light source can be easily strengthened can be obtained. In other words, particularly, in the wavelength range where the target spectral reflectance Rₜ(λ) of the target TG is large, the optimal solution of the ink amount set φ in which a difference between the target spectral reflectance Rₜ(λ) of the target TG and the predicted spectral reflectance Rₛ(λ) is not allowed can be obtained. Needless to say, since the weighting function w(λ) is derived from each of the color matching functions x(λ), y(λ), and z(λ), the evaluated value E(φ) suitable to human perception can be obtained.

### 6-2. Modified Example 2

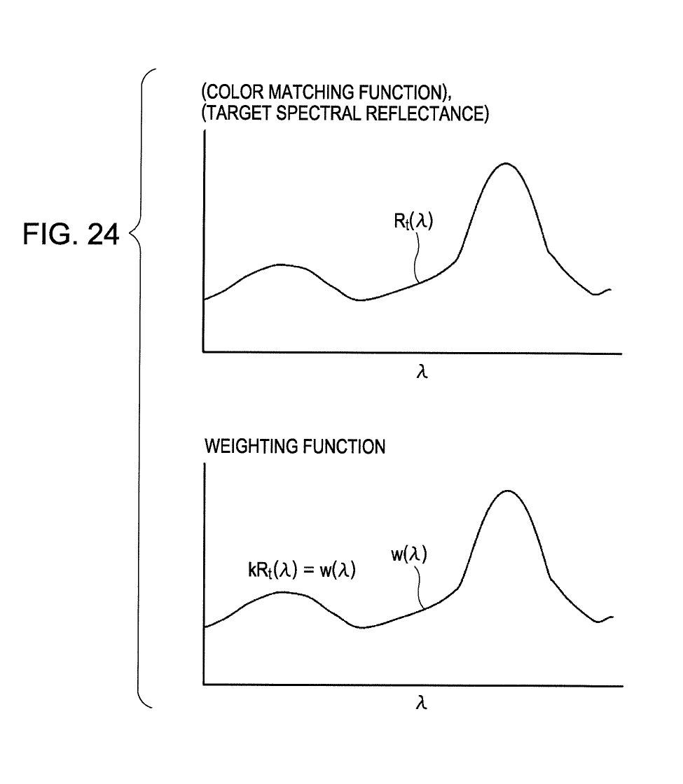

FIG. 24 diagrammatically shows the weighting function w(λ) that is set up by the ECM P3a3 according to another modified example. In the figure, the target spectral reflectance Rₜ(λ) obtained from the target TG is applied as the weighting function w(λ). As a result, particularly, in the wavelength range where the target spectral reflectance Rₜ(λ) of the target TG is large, the optimal solution of the ink amount set φ in which a difference between the spectral reflectance R(λ) of the target TG and the target spectral reflectance Rₜ(λ) is not allowed can be obtained.

### 6-3. Modified Example 3

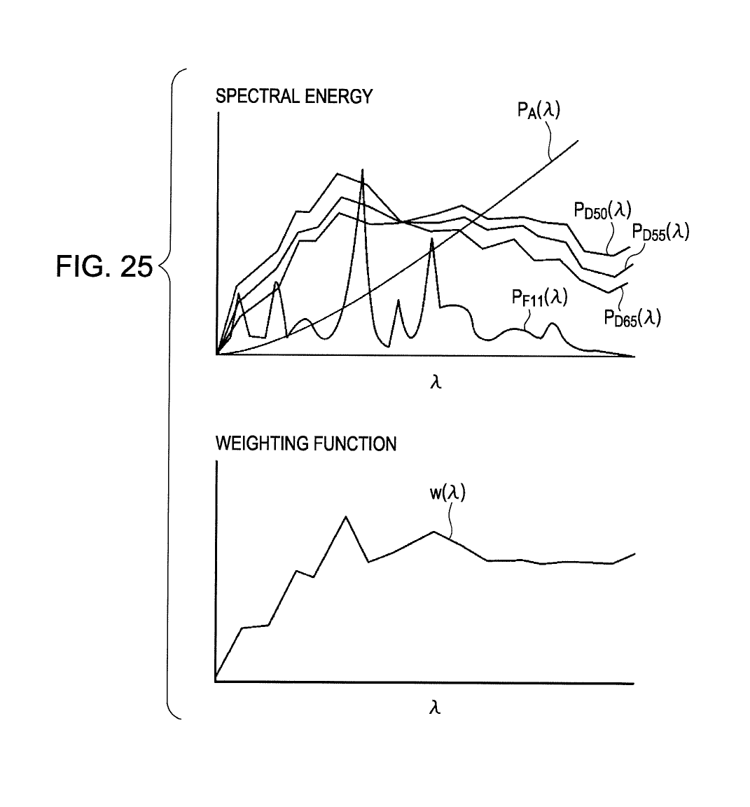

FIG. 25 diagrammatically shows the weighting function w(λ) that is set up by the ECM P3a3 according to another modified example. In the figure, the spectral energies P_{D50}(λ), P_{D55}(λ), P_{D65}(λ), P_{A}(λ), and P_{F11}(λ) of five kinds of light sources (D50 light source, D55 light source, and D65 light source of a standard daylight system, a light source of an incandescent bulb system, F11 light source of a fluorescent lamp system) are shown. In the modified example, the weighting function w(λ) can be obtained from a linear combination of the spectral energies P_{D50}(λ), P_{D55}(λ), P_{D65}(λ), P_{A}(λ), and P_{F11}(λ) by using the following Equation 10.

Equation 10

w(λ)=w₁P_{D50}(λ)+w₂P_{D55}(λ)+w₃P_{D65}(λ)+w₄P_{A}(λ)+w₅P_{F11}(λ) (10)

In the above Equation 10, w₁ to w₅ denote weighting factors that set up the weighting of the light sources. In this manner, by setting up the weighting function w(λ) that is derived from the spectral energy distributions P_{D50}(λ), P_{D55}(λ), P_{D65}(λ), P_{A}(λ), and P_{F11}(λ) of the light sources, the evaluated value E(φ) emphasizing the wavelength range where the spectrum of the spectral energy of the reflected light under each light source can be easily strengthened can be obtained. In addition, the weighting factors w₁ to w₅ may be adjusted. For example, in the case where it is desired that the reproducibility of the color in the entire light sources is to be secured with balance, w₁=w₂=w₃=w₄=w₅ is suitable. In addition, in the case where it is desired that the reproducibility of the color in the artificial light source is to be emphasized, w₁, w₂, w₃<w₄, w₅ is suitable.

### 6-4. Modified Example 4

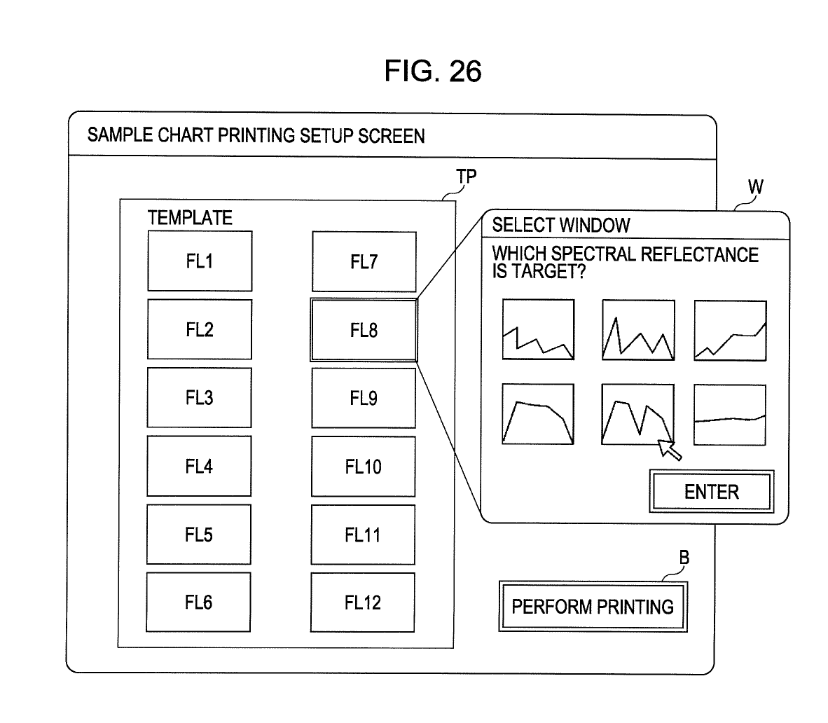

FIG. 26 shows a UI screen that is displayed on the display 40 according to a modified example. In the figure, a graph of a plurality of target spectral reflectances Rₜ(λ) is displayed on the UI screen. Due to the displaying of the UI screen, instead of measuring the target spectral reflectance Rₜ(λ) of the target TG in the step S140, a user can select a graph having a desired waveform as the target spectral reflectance Rₜ(λ) of the target TG. As a result, the target spectral reflectance Rₜ(λ) can be set up without actual measurement of the spectral reflectance. Needless to say, the user may directly edit the waveform of the graph. For example, if the target spectral reflectance Rₜ(λ) that is a goal of development of a surface of a new object is edited in advance, the sample chart SC having the target spectral reflectance Rₜ(λ) as the goal can be printed by the printer 20 without actually manufacturing the surface of the object as a test.

### 6-5. Modified Example 5

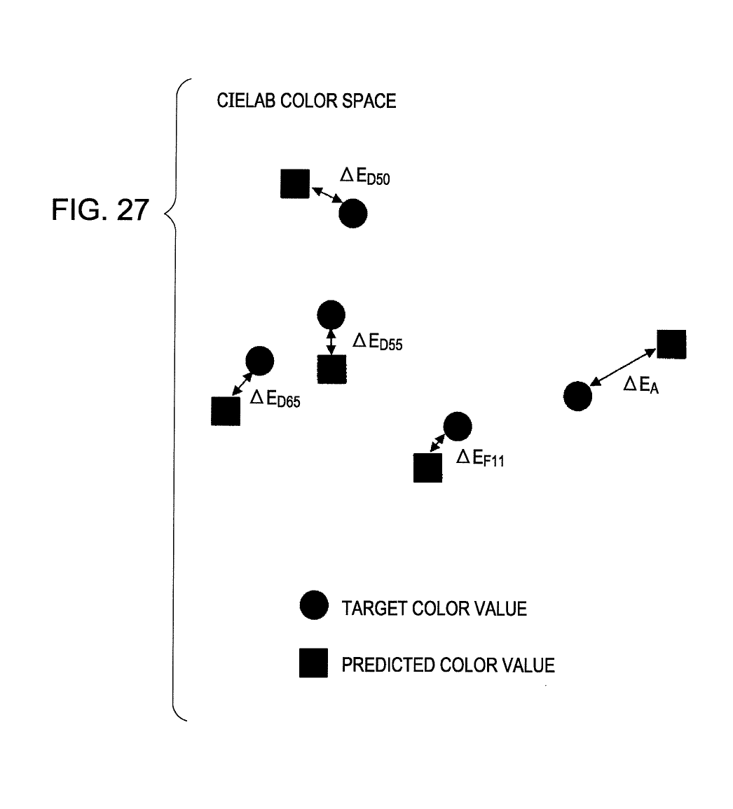

FIG. 27 diagrammatically shows the evaluated value E(φ) according to a modified example. In the figure, with respect to the target spectral reflectance Rₜ(λ) of the target TG, the color value (target color value) at the time when the above five kinds of light sources are illuminated is calculated by using the aforementioned Equation 1 and FIG. 5. On the other hand, with respect to the predicted spectral reflectance Rₛ(λ) that is predicted by the RPM P3a2, the color value (predicted color value) at the time when the above five kinds of light sources are illuminated is also calculated by using the aforementioned Equation 1 (Rₜ(λ) being replaced with Rₛ(λ)) and FIG. 5. Next, the color difference ΔE (ΔE₂₀₀₀) between the target color value and the predicted color value in each light source is calculated based on the color difference equation of CIE DE2000. Next, the color differences ΔE of the light sources are set to ΔE_{D50}, ΔE_{D55}, ΔE_{D65}, ΔE_{A}, and ΔE_{F11}, and the evaluated value E(φ) is calculated by using the following Equation 11.

Equation 11

E(φ)=w₁ΔE_{D50}+w₂ΔE_{D55}+w₃ΔE_{D65}+w₄ΔE_{A}+w₅ΔE_{F11} (11)

In the above Equation 11, w₁ to w₅ denote weighting factors that set up the weighting of the light sources. These weighting factors have almost the same properties as the weighting factor w₁ to w₅ of the aforementioned Modified Example 3. In this example, in the case where it is desired that the reproducibility of the color in the entire light sources is to be secured with balance, w₁=w₂=w₃=w₄=w₅ is suitable. In addition, in the case where it is desired that the reproducibility of the color in the artificial light source is to be emphasized, w₁, w₂, w₃<w₄, w₅ is suitable.

In the modified example, in the case where the calibration is performed, the sample chart SC as the checking patch is printed, and the spectral reflectance R(λ) as the checked spectral reflectance R_{c}(λ) is measured. Next, with respect to the target spectral reflectance Rₜ(λ) of the target TG, the target color value at the time when the five kinds of light sources are illuminated is calculated by using the aforementioned Equation 1 and FIG. 5, and the color value at the time when the checking patch is illuminated with the five kinds of light sources is calculated by using the aforementioned Equation 1 (Rₜ(λ) being replaced with R_{c}(λ)) and FIG. 5. In addition, the latter color value is referred to as a checked color value. Next, with respect to each light source, the deviation (deviation vector in the CIELAB color space) of the target color value from the checked color value is calculated. By subtracting the deviation from the target color value (by adding a reverse-directional vector of the deviation vector), the corrected target color value is calculated. In addition, by performing colorimetry while actually illuminating the target TG with the aforementioned five kinds of light sources, the checked color value may be directly obtained.

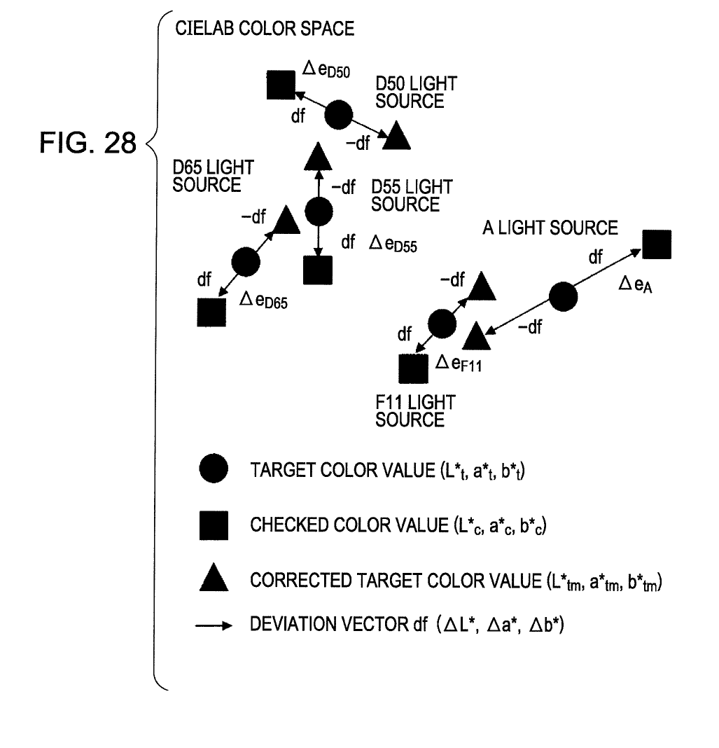

FIG. 28 diagrammatically shows the corrected target color value. In the figure, as an example, the target color value (L*ₜ, a*ₜ, b*ₜ) and the checked color value (L*_{c}, a*_{c}, b*_{c}) in the D50 light source are shown, and the behavior of calculation of the corrected target color value (L*ₜₘ, a*ₜₘ, b*ₜₘ) based on the deviation vector df(ΔL*, Δa*, Δb*) is shown in the CIELAB space. As a result, if the corrected target color value (L*ₜₘ, a*ₜₘ, b*ₜₘ) can be obtained, in the step S430, the ink amount set φ of minimizing the evaluated value E(φ) of the aforementioned Equation 11 is calculated. In addition, with respect to the evaluated value E(φ) of the aforementioned Equation 11, the color difference ΔE between the original target color value and the predicted color value is not used as ΔE_{D50}, ΔE_{D55}, ΔB_{D65}, ΔE_{A}, and ΔE_{F11}, but the color difference ΔE between the corrected target color value after the correction and the predicted color value is used as ΔE_{D50}, ΔE_{D55}, ΔE_{D65}, ΔE_{A}, and ΔE_{F11}. In addition, in the modified example, since only the color value is used as a state value, the spectral reflectance R(λ) is not necessarily acquired. Therefore, with respect to the target TG, the color value under a plurality of light sources may be acquired by using colorimetry or the like from the starting time.

In the modified example, at the time when the target color value (L*ₜ, a*ₜ, b*ₜ) and the checked color value (L*_{c}, a*_{c}, b*_{c}) with respect to each light source is obtained, the color difference ΔE(ΔE₂₀₀₀) may be calculated with respect to each light source. In addition, the color differences ΔE in the case are denoted by Δe_{D50}, Δe_{D55}, Δe_{D65}, Δe_{A}, and Δe_{F11} in the light sources. According to the color differences Δe_{D50}, Δe_{D55}, Δe_{D65}, Δe_{A}, and Δe_{F11}, it can be determined by using the color difference ΔE₂₀₀₀ to what degree of accuracy the sample chart SC is reproduced. In addition, according to an average color difference Δe that is obtained by averaging the color differences Δe_{D50}, Δe_{D55}, Δe_{D65}, Δe_{A}, and Δe_{F11} of the light sources by using the following Equation 12, the accuracy of the reproduction of the targets TG of a plurality of the light sources can be collectively determined.

$$\begin{matrix}Equation 12 & \\ Δ e = \frac{Δ {e}_{D 50} + Δ {e}_{D 55} + Δ {e}_{D 65} + Δ {e}_{A} + Δ {e}_{F 11}}{5} & ( 12 )\end{matrix}$$

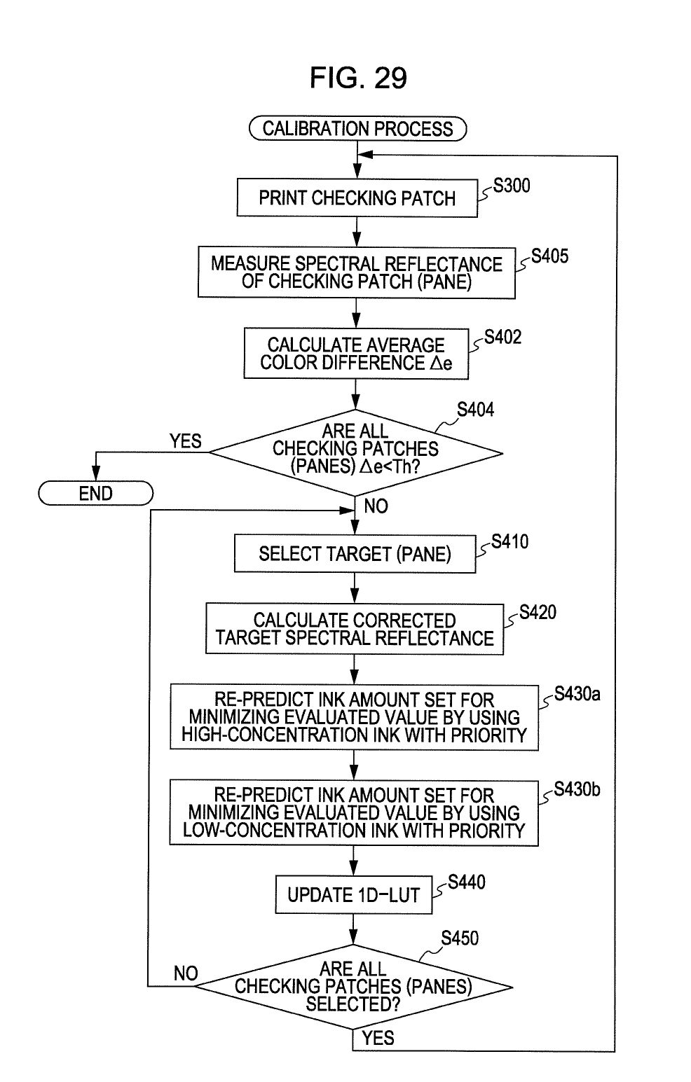

FIG. 29 shows a flow of the calibration process according to the modified example. Herein, when the sample chart SC is printed (step S300), in the step S405, the checked spectral reflectance R_{c}(λ) of each of the checking patches (panes FL1 to FL12) is measured. Next, in the step S402, the average color difference Δe between the target color value (L*ₜ, a*ₜ, b*ₜ) and the checked color value (L*_{c}, a*_{c}, b*_{c}) is calculated with respect to each of the panes FL1 to FL12. Next, it is determined in the step S404 whether or not the average color difference Δe with respect to all the panes FL1 to FL12 exceeds a predetermined threshold value Th (for example, ΔE=1.0). In the case where the average color difference Δe with respect to some of the panes FL1 to FL12 exceeds the threshold value Th, the calibration process after the step S410 is executed. When the calibration process is ended, the process returns to the step S300 again so as to print the sample chart SC again based on the updated 1D-LUT, and the same process is repeatedly executed. In this manner, until the average color difference Δe satisfies the threshold value Th, the calibration process can be repeated.

As shown in FIG. 25, since the light sources have different spectral energy spectra, it cannot be stated that the color differences Δe_{D50}, Δe_{D55}, Δe_{D65}, Δe_{A}, and Δe_{F11} of the light sources are uniformly large or small. For example, although the color differences Δe_{D50}, Δe_{D55}, and Δe_{D65} of the daylight system may be large, the color difference Δe_{A} of the incandescent lamp system may be small. In this case, it is preferable, that the calibration process of lowering the color differences Δe_{D50}, Δe_{D55}, and Δe_{D65} is performed in the state where the color difference Δe_{A} is maintained to be small. Therefore, in the modified example, the optimization of the step S430 is performed by using the evaluated value E(φ)) of the following Equation 13.

Equation 13

E(φ)=w₁ΔE_{D50}+w₂ΔE_{D55}+w₃ΔE_{D65}+w₄ΔE_{A}+w₅ΔE_{F11}+w(λ)Δr(λ) (13)

In the above Equation 13, Δr(λ) denotes an absolute value of the difference between the predicted spectral reflectance Rₛ(λ) obtained by using the ink amount set φ optimized in the step S230 and the predicted spectral reflectance Rₛ(λ) obtained by using the ink amount set φ optimized in the calibration process of the step S430. In addition, w(λ) denotes a weighting function that defines weighting for each wavelength.

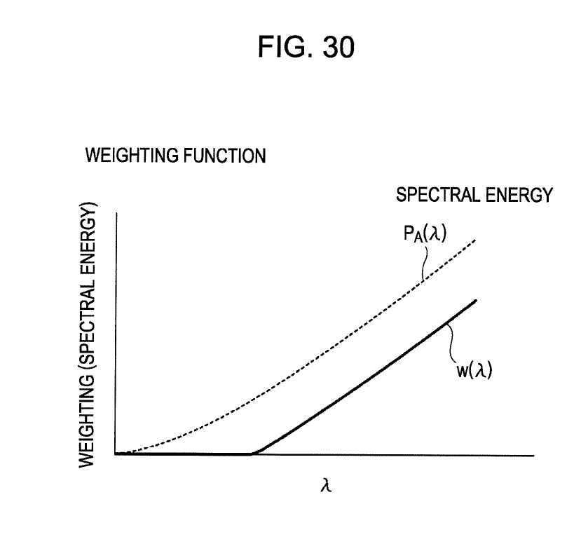

FIG. 30 is a graph showing an example of the weighting function w(λ). In the figure, the weighting function w(λ) is set up so as to represent a tendency that is almost the same as the spectrum of the spectral energy of the A light source having the smallest color difference Δe_{A}. In addition, in the wavelength range where the spectral energy is smaller than a predetermined value, the weighting function w(λ)=0 is set up. As a result, the evaluated value E(φ) can be increased according to a change in the spectral reflectance in the wavelength range that greatly contributes the color value of the A light source. In other words, the change in the spectral reflectance in the long wavelength range in the calibration process is designed to be suppressed, so that the color value of the A light source cannot be changed as far as possible. As a result, it is possible to decrease the color differences Δe_{D50}, Δe_{D55}, Δe_{D65}, and Δe_{F11} of the other light sources in the state where the color difference Δe_{A} is maintained to be small.

### 6-6. Modified Example 6

In addition, in the aforementioned embodiment, in a region corresponding to a pane F that is not selected, the printing by using the same color as the regions except for the pane F may be performed. Needless to say, in the region corresponding to the non-selected pane F, there is no need to request the spectral reproducibility. Therefore, it is preferable that the color conversion using the 3D-LUT is performed similarly to the regions except for the pane F. In addition, in the regions except for the region corresponding to the pane F designated with the target TG, a shape, a character, or a mark may be printed. For example, in the vicinity of the pane F designated with the target TG, a character indicating what the target TG is may be written.

### 6-7. Modified Example 7

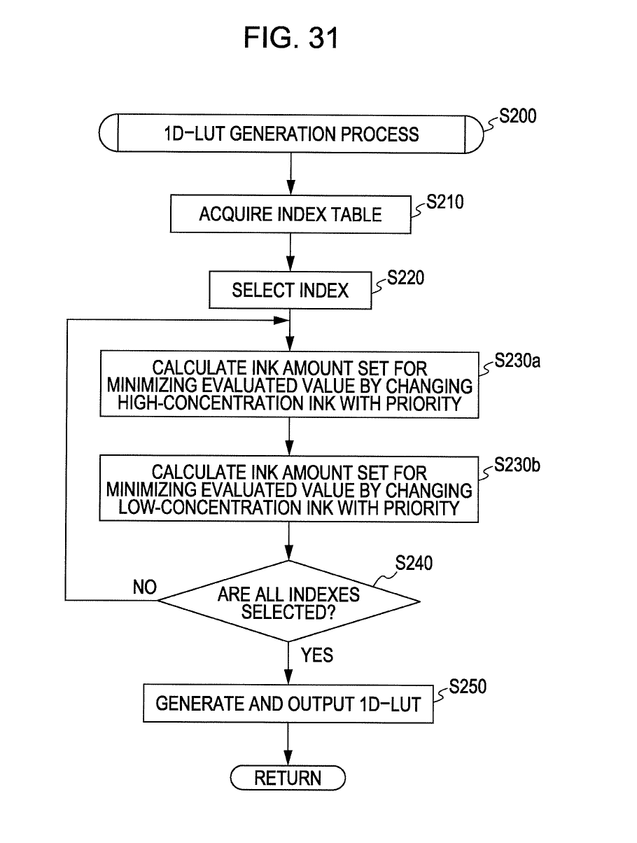

FIG. 31 is a flowchart of a 1D-LUT generation process according to a modified example. In the figure, the 1D-LUT generation process is the same as the 1D-LUT generation process of FIG. 9 except for the step S230. In the modified example, as the process of minimizing the evaluated value, similarly to the calibration process shown in FIGS. 15 and 16, the optimal solution of the ink amount set φ is configured to be calculated by separately using a process of calculating the ink amount set by using the high-concentration ink with priority (by suppressing the used amount of the low-concentration ink) and a process of calculating the ink amount set by using the low-concentration ink with priority (by suppressing the used amount of the high-concentration ink). In this manner, in the step of generating the 1D-LUT, the usage and division of the high-concentration ink amount and the low-concentration ink amount are configured to be optimized, so that the calculation amount in the calibration process can be reduced.

### 6-8. Modified Example 8

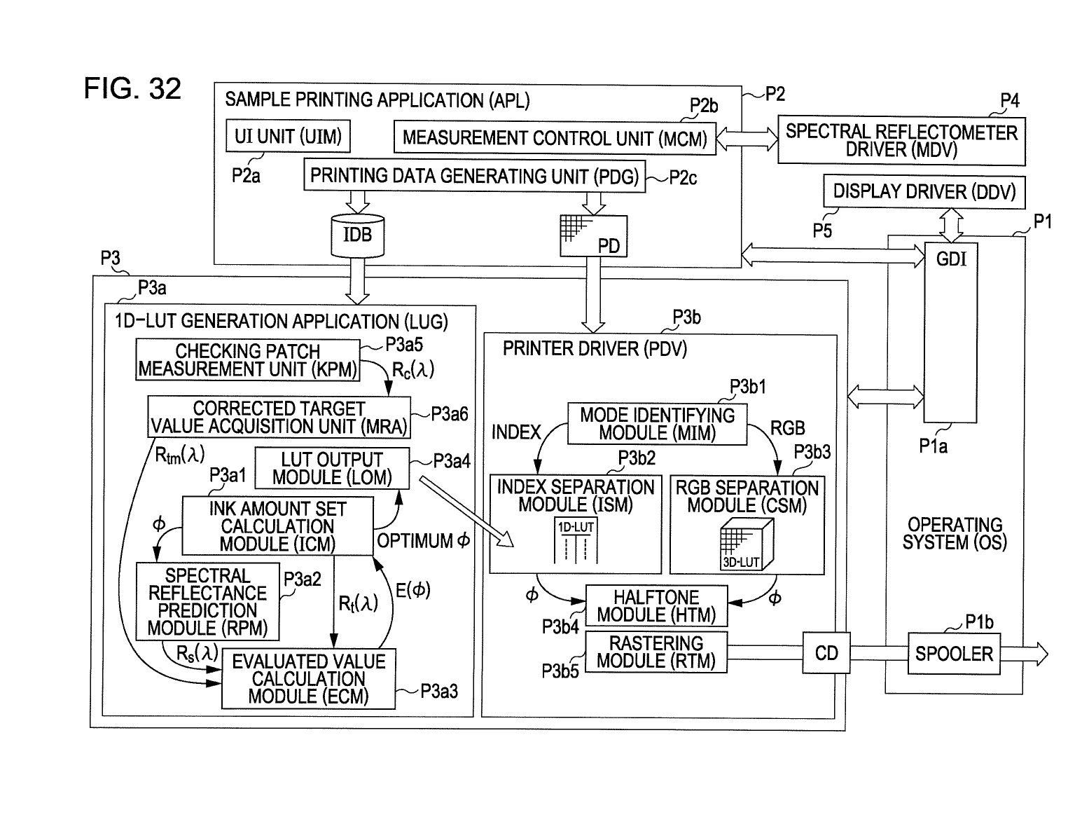

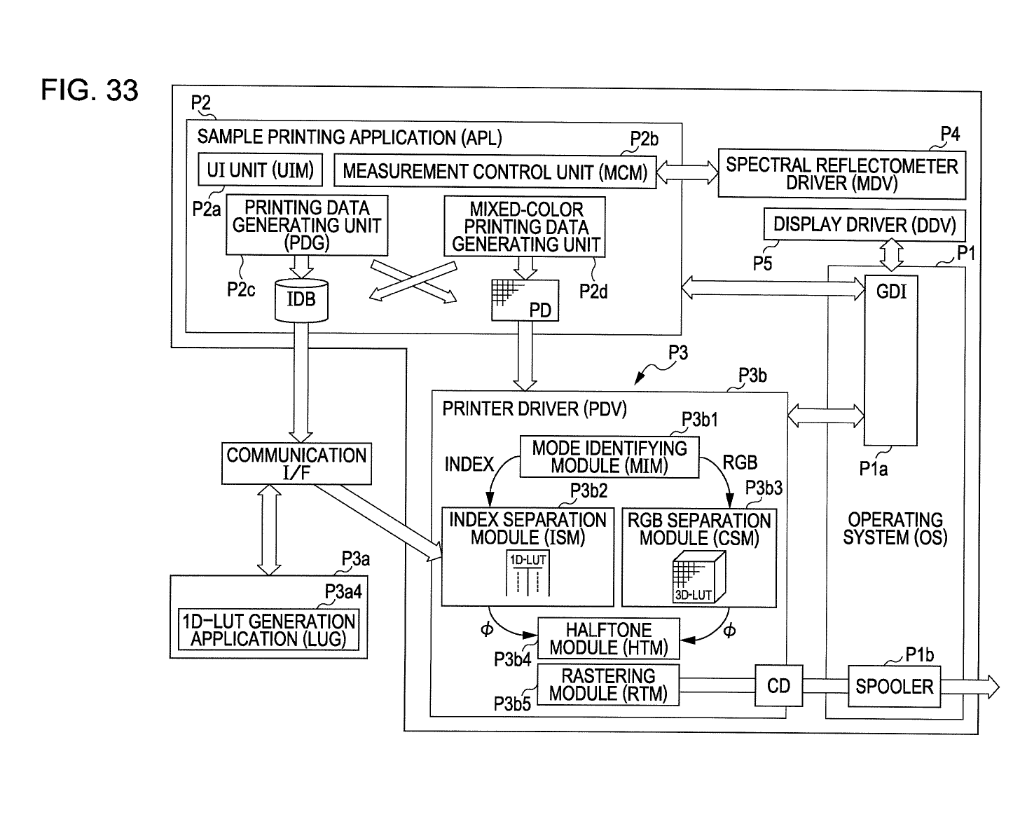

FIGS. 32 and 33 show software configurations of printing systems according to modified examples of the invention. As shown in FIG. 32, the configuration corresponding to the LUG P3a according to the aforementioned embodiment may be provided as an internal module (1D-LUT generation unit) of the PDV P3b. In addition, as shown in FIG. 33, the configuration corresponding to the LUG P3a according to the aforementioned embodiment may be executed in another computer 110. In this case, the computer 10 and the computer 110 are connected to each other through a predetermined communication interface CIF, so that the 1D-LUT generated by the LUG P3a of the computer 110 is transmitted through the communication interface CIF to the computer 10. The communication interface CIF may be connected through the Internet. In this case, the computer 10 can perform the color conversion with reference to the 1D-LUT that is acquired from the computer 110 on the Internet. In addition, the printer 20 may execute each of the software components P1 to P5. Needless to say, in the case where the hardware that executes the same process as each of the software components P1 to P5 is assembled into the printer 20, the invention can be implemented.

This application claims priority to Japanese Patent Application No. 2008-309030, filed Dec. 3, 2008, the entirety of which is incorporated by reference herein.

What is claimed is:

1. A printing control apparatus which allows a printing apparatus to perform printing by fixing on a recording medium a plurality of color materials which includes high-concentration and low-concentration color materials of which hues are substantially equal to each other with respect to at least one hue and of which concentrations are different, the printing control apparatus designating a color material amount set that is a combination of amounts used of the color materials to the printing apparatus and allowing the printing apparatus to perform printing based on the color material amount set, the printing control apparatus comprising:
a printing unit which designates the color material amount set corresponding to a designated index to the printing apparatus by referring to a lookup table that defines a correspondence between the color material amount set and an index and allows the printing apparatus to perform printing,
wherein the lookup table defines a correspondence between the index that specifies a target value that is information indicating a color of an object and a target color material amount set that is the color material amount set of which approximation to the target value is maximized when the color material is fixed on the recording medium in the printing apparatus, and
wherein the target color material amount set is a second color material amount set that is obtained by predicting a first color material amount set based on a predetermined prediction model so that the approximation is maximized while the used amount of the low-concentration color material is suppressed and by predicting the second color material amount set by using the first color material amount set as an initial value of the predetermined prediction model so that the approximation is maximized while the used amount of the high-concentration color material is suppressed.

2. The printing control apparatus according to claim 1, wherein the target value is a corrected target value that is obtained by predicting the color material amount set for reproducing the target value on the recording medium in the printing apparatus based on the predetermined prediction model, printing a checking patch by designating the predicted color material amount set to the printing apparatus, setting the corrected target value based on a deviation between a checked target value that is information indicating a color of the checking patch and a measured target value that is a measured color value of the object.

3. The printing control apparatus according to claim 2, wherein a re-checking patch is printed by designating the second color material amount set to the printing apparatus, and re-prediction of the first color material amount set and the second color material amount set is performed by using a re-corrected target value, which is calculated based on a deviation between a re-checked target value that is information indicating a color of the re-checking patch and the measured target value, as the target value.

4. The printing control apparatus according to claim 1,
wherein, in the predetermined prediction model, when the color material amount set is to be predicted, the approximation of the color material amount set is evaluated while the color material amount is changed by small amounts, each of which is smaller than a minimum unit amount that is fixed on the printing apparatus, and
wherein the color material amount set predicted based on the predetermined prediction model is obtained by performing a number rounding process on the color material amount set, of which approximation is maximized, using the unit amount as a rounding width.

5. The printing control apparatus according to claim 1,
wherein the processes of predicting the first color material amount set and the second color material amount set are repeated several times by using the predicted second color material amount set as the initial value, and
wherein, in the case where the same amounts used of the high-concentration color material of the second color material amount set are detected two times consecutively in the repeated processes, the used amount of the high-concentration color material is fixed in the next repeated processes.

6. The printing control apparatus according to claim 1, wherein, in the prediction of the second color material amount set, color change in any hue direction can be performed by using a combination of color materials excluding an ink of which the used amount is suppressed.

7. The printing control apparatus according to claim 1,
wherein the plurality of the color materials includes cyan (C), magenta (M), yellow (Y), black (K), light cyan (lc), and light magenta (lm) color materials,
wherein, in the prediction of the first color material amount set, the amounts used of at least the cyan (C), the magenta (M), and the black (K) color materials are changed with priority, and
wherein, in the prediction of the second color material amount set, the used amounts of at least the light cyan (lc), the light magenta (lm), and the yellow (Y) color materials are changed with priority.

8. A printing control system which allows a printing apparatus to perform printing by fixing on a recording medium a plurality of color materials which includes high-concentration and low-concentration color materials of which hues are substantially equal to each other with respect to at least one hue and of which concentrations are different, the printing control system designating a color material amount set that is a combination of the amounts used of the color materials to the printing apparatus and allowing the printing apparatus to perform printing based on the color material amount set, the printing control system comprising:
a printing unit which designates the color material amount set corresponding to a designated index to the printing apparatus by referring to a lookup table that defines a correspondence between the color material amount set and an index and allows the printing apparatus to perform printing,
wherein the lookup table defines a correspondence between the index that specifies a target value that is information indicating a color of an object and a target color material amount set that is the color material amount set of which approximation to the target value is maximized when the color material is fixed on the recording medium in the printing apparatus,
wherein the target color material amount set is a second color material amount set that is obtained by predicting a first color material amount set based on a predetermined prediction model so that the approximation is maximized while the used amount of the low-concentration color material is suppressed and by predicting the second color material amount set by using the first color material amount set as an initial value of the predetermined prediction model so that the approximation is maximized while the used amount of the high-concentration color material is suppressed, and
wherein the printing apparatus includes a printing performing unit which performs printing based on the color material amount set.

9. A printing control program which allows a computer to execute a function which allows a printing apparatus to perform printing by fixing on a recording medium a plurality of color materials which includes high-concentration and low-concentration color materials of which hues are substantially equal to each other with respect to at least one hue and of which concentrations are different, wherein the function designates a color material amount set that is a combination of the amounts used of the color materials to the printing apparatus and allows the printing apparatus to perform printing based on the color material amount set,
wherein the printing control program causes the computer to execute a printing function which designates the color material amount set corresponding to a designated index to the printing apparatus by referring to a lookup table that defines a correspondence between the color material amount set and an index and allows the printing apparatus to perform printing,
wherein the lookup table defines a correspondence between the index that specifies a target value that is information indicating a color of an object and a target color material amount set that is the color material amount set of which approximation to the target value is maximized when the color material is fixed on the recording medium in the printing apparatus, and
wherein the target color material amount set is a second color material amount set that is obtained by predicting a first color material amount set based on a predetermined prediction model so that the approximation is maximized while the used amount of the low-concentration color material is suppressed and by predicting the second color material amount set by using the first color material amount set as an initial value of the predetermined prediction model so that the approximation is maximized while the used amount of the high-concentration color material is suppressed.
